(19) United States
(12) Patent Application Publication
(10) Pub. No.: US 2008/0241588 A1
(43) Pub. Date: Oct. 2, 2008

(54) ORGANIC ELECTROLUMINESCENCE DEVICE AND DISPLAY

(75) Inventors: Chishio Hosokawa, Sodegaura-shi (JP); Takayasu Sado, Sodegaura-shi (JP); Kiyoshi Ikeda, Sodegaura-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Idemitsu Kosan Co., Ltd., Chiyoda-ku (JP)

(21) Appl. No.: 12/044,291

(22) Filed: Mar. 7, 2008

(30) Foreign Application Priority Data
Mar. 9, 2007 (JP) 2007-061092

(51) Int. Cl. C09K 11/00

(52) U.S. Cl. 428/690

(57) ABSTRACT

In an organic electroluminescence device including a cathode and an anode, at least an emitting layer and an electron transporting layer are provided between the cathode and the anode. The emitting layer contains a host material formed of a naphthacene derivative represented by the following formula (1) and a dopant material formed of a diketopyrolopyrrol derivative represented by the following formula (2). The electron transporting layer is preferably a benzoimidazole derivative.

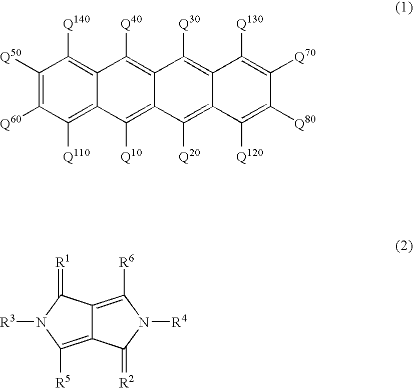

### BACKGROUND OF THE INVENTION

1. Field of the Invention

The present invention relates to an organic electroluminescence device (organic EL device) and a display that use a naphthacene derivative and a diketopyrrolopyrrole derivative together.

2. Description of Related Art

Organic electroluminescence (EL) devices have been known. Organic EL devices formed from organic materials have been vigorously studied since a report on a low voltage-driven organic EL device formed by laminating layers was made by C. W. Tang et al. of Eastman Kodak Company (see Document 1: Applied Physics Letters, vol. 51, page 913, by C. W. Tang and S. A. Vanslyke, 1987).

Known examples of an emitting material used for an organic EL device are a chelate complex such as a tris(8-quinolinol)aluminum (Alq) complex, a coumarin complex, a tetraphenylbutadiene derivative, a bisstyrylarylene derivative, an oxadiazole derivative or the like. These emitting materials, which have been reported to emit blue to red light in a visible region, are expected to be applied to color-display devices (e.g., Document 2: JP-A-08-239655, Document 3: JP-A-07-138561, Document 4: JP-A-03-200889 and the like). However, luminous efficiency and lifetime of such a device has been so insufficient that the device has not been practically applicable. While a full color display requires three primary colors of blue, green and red, among them, a red-emitting device with high efficiency has been demanded.

For instance, Document 5 (JP-A-08-311442) has recently disclosed a red-emitting device whose emitting layer is added with a naphthacene derivative or a pentacene derivative. However, although the red-emitting device is excellent in purity of red color, the red-emitting device requires voltage of 11V to be applied, and time lapsed until the luminescent intensity decreases to half is approximately 150 hours, i.e., the performance of the device is insufficient. Document 6 (JP-A-03-162481) discloses a device whose emitting layer is added with a dicyanomethylene (DCM)-based compound. However, the device exhibits insufficient purity of red color. Document 7 (JP-A-2001-81451) discloses a red-emitting device whose emitting layer is added with an amine-based aromatic compound. However, although the emitting device exhibits excellent CIE (Commission Internationale d'Eclairage) chromaticity (0.64, 0.33) and chromatic purity, the device requires high voltage for driving. Document 8 (WO/01/23497) and Document 9 (JP-A-2003-40845) disclose devices in which an amine-based aromatic compound and an Alq compound are used for the emitting layer. However, although emitting red light, the device exhibits low efficiency and short lifetime.

Document 10 (JP-A-2003-81924) discloses devices in which an amine-based aromatic compound and DPVDPAN are used for the emitting layer. However, high-efficient one of the devices emits orange light while the red-emitting one of the devices exhibits low efficiency.

Document 11 (JP-A-2001-307885) discloses a device in which a dicyanoanthracene derivative and an indenoperylene derivative are used for the emitting layer while a metal complex is used for the electron transporting layer. However, the device emits light of red orange color.

Document 12 (JP-A-2003-338377) discloses a device in which a fluoranthene derivative and an indenoperylene derivative are used for the emitting layer while a fluoranthene derivative is used for the electron transporting layer. However, the device does not exhibit practically-applicable efficiency.

### SUMMARY OF THE INVENTION

An object of the present invention is to provide an practically-applicable organic EL device and a practically-applicable display excellent in efficiency, lifetime and chromatic purity.

After conducting concentrated studies in order to achieve such an object, the inventors have found that an organic EL device exhibits longer lifetime and higher efficiency by using a naphthacene derivative and a diketopyrrolopyrrole derivative in at least one layer of organic compound layers of the organic EL device, and reached the present invention.

An organic electroluminescence device according to an aspect of the present invention includes: a cathode; an anode; and an emitting layer provided between the cathode and the anode, in which the emitting layer contains a host and a dopant, the host is a naphthacene derivative represented by a formula (1) as follows, and the dopant is a diketopyrolopyrrol derivative represented by a formula (2) as follows,

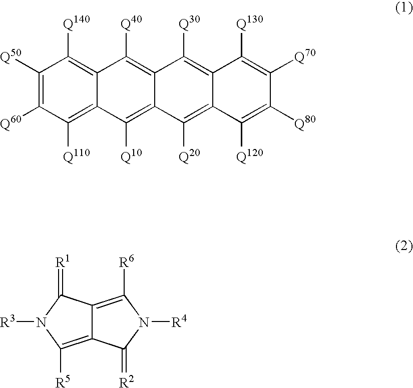

In the formula (1), Q¹⁰, Q²⁰, Q³⁰, Q⁴⁰, Q⁵⁰, Q⁶⁰, Q⁷⁰, Q⁸⁰, Q¹¹⁰, Q¹²⁰, Q¹³⁰ and Q¹⁴⁰ each represent a hydrogen atom, a substituted or unsubstituted alkyl group having 1 to 20 carbon atoms, a substituted or unsubstituted aryl group having 6 to 30 carbon atoms, a substituted or unsubstituted amino group, a substituted or unsubstituted alkoxy group having 1 to 20 carbon atoms, a substituted or unsubstituted alkylthio group having 1 to 20 carbon atoms, a substituted or unsubstituted aryloxy group having 6 to 30 carbon atoms, a substituted or unsubstituted arylthio group having 6 to 30 carbon atoms, a substituted or unsubstituted alkenyl group having 1 to 20 carbon atoms, a substituted or unsubstituted aralkyl group having 7 to 30 carbon atoms, or a substituted or unsubstituted heterocyclic group. Q¹⁰, Q²⁰, Q³⁰, Q⁴⁰, Q⁵⁰, Q⁶⁰, Q⁷⁰, Q⁸⁰, Q¹¹⁰, Q¹²⁰, Q¹³⁰ and Q¹⁴⁰ may be mutually the same or different.

In the formula (2), R¹ and R² each represent an oxygen atom or a nitrogen atom substituted by a cyano group. R³ and R⁴ each representing a hydrogen atom, a halogen atom, an alkyl group, an alkenyl group, an aryl group, a heterocyclic group or COOR⁷. R⁷ representing an alkyl group, an alkenyl group, an aryl group or a heterocyclic group. R⁵ and R⁶ each representing an aryl group or a heterocyclic group. R³ and R⁴ may be mutually the same or different, and may be substituted or unsubstituted. R⁵ and R⁶ may be mutually the same or different, and may be substituted or unsubstituted. R⁷ may be substituted or unsubstituted.

According to the aspect of the present invention, since the emitting layer contains the host formed of a naphthacene derivative and the dopant formed of a diketopyrolopyrrol derivative, the organic EL device having practically-applicable efficiency and lifetime can be realized.

According to the aspect of the present invention, it is preferable that the diketopyrolopyrrol derivative represented by the formula (2) is a diketopyrolopyrrol derivative represented by a formula (2-1) as follows.

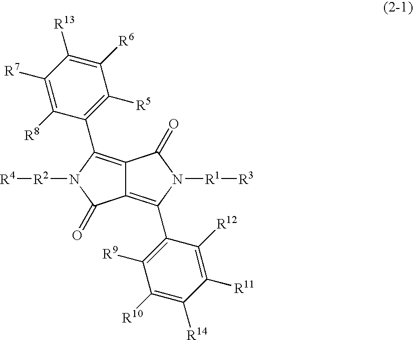

In the formula (2-1): R¹ and R² each represent a substituted or unsubstituted alkylene group; R³ and R⁴ each represent a substituted or unsubstituted aliphatic heterocyclic group or a substituent represented by a formula (2-2) as follows. R⁵ to R¹⁴ each represent a hydrogen atom or a substituent. At least one of R⁵ to R¹⁴ is an amino group represented by a formula (2-3) as follows.

-X—R¹⁵ (2-2)

In the formula (2-2): X represents an oxygen atom or a sulfur atom; R¹⁵ represents substituted or unsubstituted univalent aliphatic hydrocarbon, substituted or unsubstituted univalent aromatic hydrocarbon or a substituted or unsubstituted univalent aromatic heterocyclic group.

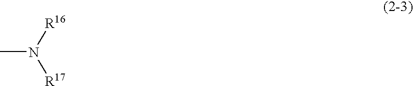

In the formula (2-3), R¹⁶ and R¹⁷ each represent a hydrogen atom, substituted or unsubstituted univalent aliphatic hydrocarbon, substituted or unsubstituted univalent aromatic hydrocarbon or a substituted or unsubstituted univalent aromatic heterocyclic group.

According to the aspect of the present invention, it is preferable that the diketopyrolopyrrol derivative represented by the formula (2) is a diketopyrolopyrrol derivative represented by a formula (24) as follows.

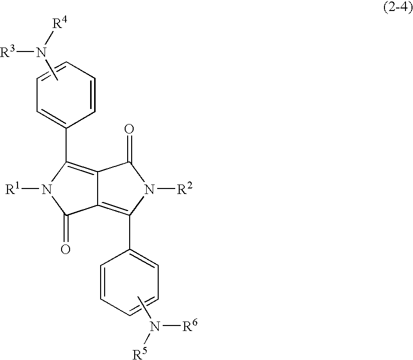

In the formula (2-4), R¹ to R⁶ each represent a substituted or unsubstituted alkyl group, a substituted or unsubstituted aryl group, or a substituted or unsubstituted heterocyclic group.

In the formula (24), R¹ and R² each represent a substituted or unsubstituted alkylene group. R³ and R⁴ each represent a substituted or unsubstituted aliphatic heterocyclic group or a substituent represented by a formula (2-5) as follows. R⁵ to R¹² each represent a hydrogen atom or a substituent. R¹⁸ to R²¹ each represent a hydrogen atom, a substituted or unsubstituted univalent aliphatic hydrocarbon group, a substituted or unsubstituted univalent aromatic hydrocarbon group, or a substituted or unsubstituted univalent aromatic heterocyclic group.

-X—R¹⁵ (2-5)

In the formula (2-5), X represents an oxygen atom or a sulfur atom, and R¹⁵ represents substituted or unsubstituted univalent aliphatic hydrocarbon, substituted or unsubstituted univalent aromatic hydrocarbon or a substituted or unsubstituted univalent aromatic heterocyclic group.

According to the aspect of the present invention, it is preferable that the diketopyrolopyrrol derivative represented by the formula (2) is a diketopyrolopyrrol derivative represented by a formula (2-6) as follows.

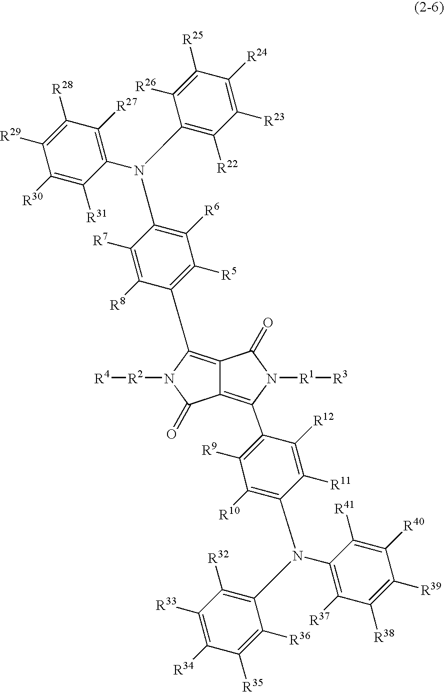

In the formula (2-6), R¹ and R² each represent a substituted or unsubstituted alkylene group. R³ and R⁴ each represent a substituted or unsubstituted aliphatic heterocyclic group or a substituent represented by a formula (2-7) as follows. R⁵ to R¹² each represent a hydrogen atom or a substituent; and R⁵ to R¹² and R²² to R⁴¹ each represent a hydrogen atom or a substituent

-X—R¹⁵ (2-7)

In the formula (2-7), X represents an oxygen atom or a sulfur atom, and R¹⁵ represents substituted or unsubstituted univalent aliphatic hydrocarbon, substituted or unsubstituted univalent aromatic hydrocarbon or a substituted or unsubstituted univalent aromatic heterocyclic group.

According to the aspect of the present invention, it is preferable that at least one of Q¹⁰, Q²⁰, Q³⁰ and Q⁴⁰ in the naphthacene derivative represented by the formula (1) is a substituted or unsubstituted aryl group having 6 to 30 carbon atoms.

According to the aspect of the present invention, it is preferable that the naphthacene derivative represented by the formula (1) is a naphthacene derivative represented by a formula (3) as follows.

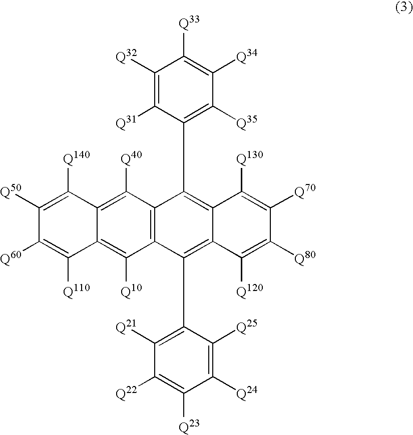

In the formula (3), where Q¹⁰, Q²¹ to Q²⁵, Q³¹ to Q³⁵, Q⁴⁰ to Q⁸⁰ and Q¹¹⁰ to Q¹⁴⁰ each represent a hydrogen atom, a substituted or unsubstituted alkyl group, a substituted or unsubstituted aryl group, a substituted or unsubstituted amino group, a substituted or unsubstituted alkoxy group, a substituted or unsubstituted alkylthio group, a substituted or unsubstituted aryloxy group, a substituted or unsubstituted arylthio group, a substituted or unsubstituted alkenyl group, a substituted or unsubstituted aralkyl group, or a substituted or unsubstituted heterocyclic group. Q¹⁰, Q²¹ to Q²⁵, Q³¹ to Q³⁵, Q⁴⁰ to Q⁸⁰ and Q¹¹⁰ to Q¹⁴⁰ may be mutually the same or different. Adjacent two or more of Q²¹ to Q²⁵ and Q³¹ to Q³⁵ may be mutually bonded to form a cyclic structure.

According to the aspect of the present invention, it is preferable that at least one of Q²¹, Q²⁵, Q³¹ and Q³⁵ in the naphthacene derivative represented by the formula (3) represents a substituted or unsubstituted alkyl group, a substituted or unsubstituted aryl group, a substituted or unsubstituted amino group, a substituted or unsubstituted alkoxy group, a substituted or unsubstituted alkylthio group, a substituted or unsubstituted aryloxy group, a substituted or unsubstituted arylthio group, a substituted or unsubstituted alkenyl group, a substituted or unsubstituted aralkyl group, or a heterocyclic group.

According to the above structure, the naphthacene derivative represented by the formula (3) has a substituent in at least one ortho position of two benzene rings bonded to naphthacene.

By introducing substituent(s) to ortho position(s) of the two benzene rings bonded to naphthacene, a steric hindrance is caused between the introduced substituent(s) and the naphthacene skeleton. The steric hindrance directs the introduced substituent(s) to face in an out-of-plane direction of the naphthacene skeleton. Then, the substituent(s) directed in the out-of-plane direction prevents association of naphthacene derivatives with each other.

When two or more of Q₂₁, Q₂₅, Q₃₁ and Q₃₅ are substituents, the two or more of Q₂₁, Q₂₅, Q₃₁ and Q₃₅ may be mutually the same or different. In addition, adjacent two or more of Q₂₁ to Q₂₅ and Q₃₁ to Q₃₅ may be mutually bonded to form a cyclic structure.

An example of the substituent is a substituted or unsubstituted phenyl group.

Two or more of the ortho positions of the two benzene rings bonded to naphthacene are preferably substituted.

According to the aspect of the present invention, it is preferable that the dopant is contained in the emitting layer at a doping concentration of 0.1 to 10 mass %. It is more preferable that the dopant is contained in the emitting layer at a doping concentration of 0.5 to 2.0 mass %.

According to the aspect of the present invention, it is preferable that the organic EL device further includes an electron transporting layer provided between the cathode and the anode, in which the electron transporting layer comprises a compound represented by a formula (4) as follows.

(A)ₘ-(B)ₙ (4)

In the formula, A represents a condensed aromatic hydrocarbon group having three or more rings, B represents a substituted or unsubstituted heterocyclic group, and m and n each represent an integer in a range of 1 to 6.

According to the aspect of the present invention, it is preferable that A in the compound represented by the formula (4) has a skeleton in its molecule, the skeleton selected from a group consisting of anthracene, phenanthrene, naphthacene, pyrene, chrysene, benzoanthracene, pentacene, dibenzoanthracene, benzopyrene, florene, benzoflorene, fluoranthene, benzofluoranthene, naphthofluoranthene, dibenzoflorene, dibenzopyrene and dibenzofluoranthene.

According to the aspect of the present invention, it is preferable that B in the compound represented by the formula (4) is a nitrogen-containing heterocyclic group.

According to the aspect of the present invention, it is preferable that the nitrogen-containing heterocyclic group in the compound represented by the formula (4) has a skeleton in its molecule, the skeleton selected from a group consisting of pyridine, pyrimidine, pyrazine, pyridazine, triazine, quinoline, quinoxaline, acridine, imidazopyridine, imidazopyrimidine, phenanthroline, pyrazole, imidazole and benzoimidazole.

According to the aspect of the present invention, it is preferable that the compound represented by the formula (4) is a benzoimidazole derivative represented by a formula (5) or a formula (6) as follows.

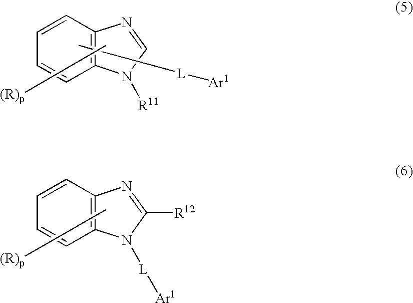

In the formulae: R represents a hydrogen atom, a substituted or unsubstituted aryl group having 6 to 60 carbon atoms, a substituted or unsubstituted pyridyl group, a substituted or unsubstituted quinolyl group, a substituted or unsubstituted alkyl group having 1 to 20 carbon atoms or a substituted or unsubstituted alkoxy group having 1 to 20 carbon atoms; p represents an integer in a range of 1 to 4; R¹¹ represents a substituted or unsubstituted aryl group having 6 to 60 carbon atoms, a substituted or unsubstituted pyridyl group, a substituted or unsubstituted quinolyl group, a substituted or unsubstituted alkyl group having 1 to 20 carbon atoms or an alkoxy group having 1 to 20 carbon atoms; R¹² represents a hydrogen atom, a substituted or unsubstituted aryl group having 6 to 60 carbon atoms, a substituted or unsubstituted pyridyl group, a substituted or unsubstituted quinolyl group, a substituted or unsubstituted alkyl group having 1 to 20 carbon atoms or a substituted or unsubstituted alkoxy group having 1 to 20 carbon atoms; L represents a substituted or unsubstituted arylene group having 6 to 60 carbon atoms, a substituted or unsubstituted pyridinylene group, a substituted or unsubstituted quinolinylene group, a substituted or unsubstituted fluorenylene group; and Ar¹ represents a substituted or unsubstituted aryl group having 6 to 60 carbon atoms, a substituted or unsubstituted pyridyl group or a substituted or unsubstituted quinolyl group.

At least one of R, R¹¹, R¹², L and Ar¹ is a substituted or unsubstituted condensed aromatic hydrocarbon group having three or more rings in the compound represented by the formula (4).

According to the aspect of the present invention, it is preferable that the emitting layer emits light of orange to red.

A display according to another aspect of the present invention includes the above-described organic electroluminescence device.

According to the above arrangement, since the display is formed from the above-described organic electroluminescence device, the display can exhibit high efficiency, long lifetime and excellent chromatic purity.

The present invention can provide a practically-applicable organic EL device that exhibits high efficiency, long life and excellent chromatic purity.

In addition, according to the present invention, by selecting a suitable compound for the materials of the electron transporting layer and the emitting layer, the organic EL device can exhibit higher efficiency. Specifically, with the arrangement according to the present invention, generation of exciters in the electron transporting layer can be prevented, thereby providing a highly chromatically-pure organic EL device whose micro emission from the electron transporting layer is further reduced In addition, for the same reason(s), the lifetime of the device can be prolonged.

### BRIEF DESCRIPTION OF THE DRAWINGS

FIG. 1 shows a first embodiment of an organic EL device according to the present invention.

### DETAILED DESCRIPTION OF PREFERRED EMBODIMENT(S)

### [Arrangement of Organic EL Device]

Representative exemplary arrangements of an organic EL device usable in the present invention will be described below. As a matter of course, the present invention is not limited thereto.

(1) anode/emitting layer/electron transporting layer/cathode

(2) anode/hole transporting layer/emitting layer/electron transporting layer/cathode

(3) anode/hole injecting layer/hole transporting layer/emitting layer/electron transporting layer/cathode

(4) anode/hole transporting layer/emitting layer/electron transporting layer/electron injecting layer/cathode

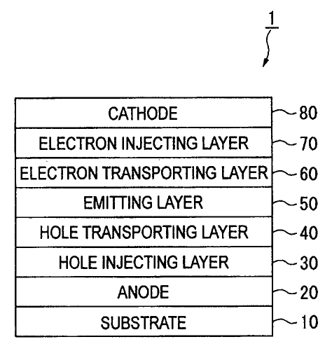

(5) anode/hole injecting layer/hole transporting layer/emitting layer/electron transporting layer/electron injecting layer/cathode (FIG. 1)

(6) anode/insulating layer/hole transporting layer/emitting layer/electron transporting layer/cathode

(7) anode/hole transporting layer/emitting layer/electron transporting layer/insulating layer/cathode

(8) anode/insulating layer/hole transporting layer/emitting layer/electron transporting layer/insulating layer/cathode

(9) anode/hole injecting layer/hole transporting layer/emitting layer/electron transporting layer/insulating layer/cathode

(10) anode/insulating layer/hole injecting layer/hole transporting layer/emitting layer/electron transporting layer/electron injecting layer/cathode

(11) anode/insulating layer/hole injecting layer/hole transporting layer/emitting layer/electron transporting layer/electron injecting layer/insulating layer/cathode

Among the above, the arrangement (2), (3), (4), (5), (8), (9) or (11) is typically preferable.

The organic EL device according to the present invention includes an anode, a cathode and a single-layered or plural-layered organic layer including an emitting layer. At least one layer of the organic layer contains a host formed of a naphthacene derivative and a dopant formed of a diketopyrolopyrrol derivative.

An exemplary arrangement of the organic EL device according to the present invention is shown in FIG. 1. In FIG. 1, the organic EL device 1 includes an anode 20, a hole injecting layer 30, a hole transporting layer 40, an emitting layer 50, an electron transporting layer 60, an electron injecting layer 70 and a cathode 80, which are all laminated on a substrate 10 in this order. The hole injecting layer 30, the hole transporting layer 40, the emitting layer 50, the electron transporting layer 60 and the electron injecting layer 70 correspond to the organic layer interposed between the cathode 80 and the anode 20. At least one of the above layers contains a host material formed of a naphthacene derivative and a dopant material formed of a diketopyrolopyrrol derivative. Preferably, the emitting layer contains a naphthacene derivative and a diketopyrolopyrrol derivative.

Functions or the like of the layers of the organic EL device will be described below.

### [Light-Transmissive Substrate]

When the organic EL device is to emit light through the substrate (i.e., when the organic EL device is bottom-emission type), the organic EL device according to the present invention is manufactured on a light-transmissive substrate. The light-transmissive plate, which supports the organic EL device, is preferably a smoothly-shaped substrate that transmits 50% or more of light in a visible region of 400 nm to 700 nm.

The light-transmissive plate is exemplarily a glass plate, a polymer plate or the like. For the glass plate, such materials as soda-lime glass, barium/strontium-containing glass, lead glass, aluminosilicate glass, borosilicate glass, barium borosilicate glass, quartz and the like can be used. For the polymer plate, such materials as polycarbonate, acryl, polyethylene terephthalate, polyether sulfide, polysulfone and the like can be used. In addition, the light-transmissive plate may be a TFT substrate on which a TFT (thin film transistor) for driving is formed.

On the other hand, when the organic EL device is to emit light from its top portion (i.e., when the organic EL device is top-emission type), the light-transmissive plate is required to be provided with a light reflector, an exemplary material of which is a metal such as aluminum.

### [Anode]

The anode of the organic EL device is used for injecting holes into the hole transporting layer or the emitting layer. It is effective that the anode includes a work function of 4.5 eV or more. Exemplary materials for the anode are indium-tin oxide (ITO), tin oxide (NESA), indium zinc oxide alloy (IZO), gold, silver, platinum and copper.

One of the above materials may be singularly used, or alloys formed by mixing the above materials and materials formed by adding other element(s) to the above material(s) may be suitably selected as the material of the anode.

The anode may be made by forming a thin film from the above electrode materials through methods such as vapor deposition and sputtering.

When the organic EL device is bottom-emission type, the anode preferably transmits more than 10% of light emitted by the emitting layer. Sheet resistance of the anode is preferably several hundreds Ω/square or lower. Although depending on the material of the anode, thickness of the anode is typically in a range of 10 nm to 1 μm, and preferably in a range of 10 to 200 nm.

### [Emitting Layer]

The emitting layer of the organic EL device has functions described below. Specifically, the emitting layer has:

(i) injecting function: a function for accepting, when an electrical field is applied, the holes injected by the anode or the hole injecting/transporting layer, or the electrons injected by the cathode or the electron injecting/transporting layer;

(ii) transporting function: a function for transporting injected electric charges (the electrons and the holes) by the force of the electrical field; and

(iii) emitting function; a function for providing a condition for recombination of the electrons and the holes to emit light.

Although injectability of the holes may differ from that of the electrons and transporting capabilities represented by mobilities of the holes and the electrons may differ from each other, the emitting layer preferably transports at least either one of the electric charges.

As a method to form the emitting layer, known methods such as vapor deposition, spin coating and an LB (Langmuir Blodgett) method may be employed. The emitting layer is preferably a molecular deposit film.

The molecular deposit film means a thin film formed by depositing a material compound in gas phase or a film formed by solidifying a material compound in a solution state or in liquid phase. The molecular deposit film is generally distinguished from a thin film formed by the LB method (molecular accumulation film) by differences in aggregation structures, higher order structures and functional differences arising therefrom.

As disclosed in JP-A-57-51781, the emitting layer can be formed from a thin film formed by spin coating or the like, the thin film being formed from a solution prepared by dissolving a binder (e.g. a resin) and a material compound in a solvent.

The emitting layer of the present invention contains a host and a dopant.

The emitting layer is preferably doped with a dopant material at a doping concentration of 0.1 to 10 mass %, more preferably 0.5 to 2.0 mass %.

The emitting layer preferably emits light of orange to red.

The host is a naphthacene derivative represented by the above formula (1).

In the formula (1), Q¹⁰, Q²⁰, Q³⁰, Q⁴⁰, Q⁵⁰, Q⁶⁰, Q⁷⁰, Q⁸⁰, Q¹¹⁰, Q¹²⁰, Q¹³⁰ and Q¹⁴⁰ each represent a hydrogen atom, a substituted or unsubstituted alkyl group having 1 to 20 carbon atoms, a substituted or unsubstituted aryl group having 6 to 30 carbon atoms, a substituted or unsubstituted amino group, a substituted or unsubstituted alkoxy group having 1 to 20 carbon atoms, a substituted or unsubstituted alkylthio group having 1 to 20 carbon atoms, a substituted or unsubstituted aryloxy group having 6 to 30 carbon atoms, a substituted or unsubstituted arylthio group having 6 to 30 carbon atoms, a substituted or unsubstituted alkenyl group having 1 to 20 carbon atoms, a substituted or unsubstituted aralkyl group having 7 to 30 carbon atoms, or a substituted or unsubstituted heterocyclic group. Q¹⁰, Q²⁰, Q³⁰, Q⁴⁰, Q⁵⁰, Q⁶⁰, Q⁷⁰, Q⁸⁰, Q¹¹⁰, Q¹²⁰, Q¹³⁰ and Q¹⁴⁰ may be mutually the same or different.

In the above formula (1), Q¹⁰, Q²⁰, Q³⁰ and Q⁴⁰ (collectively referred to as Q¹⁰ to Q⁴⁰) are each preferably selected from a group consisting of a hydrogen atom, a substituted or unsubstituted alkyl group having 1 to 20 carbon atoms, a substituted or unsubstituted aryl group having 6 to 30 carbon atoms, a substituted or unsubstituted amino group, a substituted or unsubstituted heterocyclic group and a substituted or unsubstituted alkenyl group having 1 to 20 carbon atoms. More preferably, Q¹⁰ to Q⁴⁰ are aryl groups. Particularly, a structure where Q¹⁰ and Q⁴⁰ are hydrogen atoms while Q²⁰ and Q³⁰ are the above substituents is also preferable.

In addition, although a structure where Q¹⁰ and Q⁴⁰ are the same while Q²⁰ and Q³⁰ are the same is preferable, Q¹⁰ to Q⁴⁰ may be mutually different.

In the above formula, Q⁵⁰, Q⁶⁰, Q⁷⁰ and Q⁸⁰ (collectively referred to as Q⁵⁰ to Q⁸⁰) are each preferably selected from a group consisting of a hydrogen atom, a substituted or unsubstituted alkyl group having 1 to 20 carbon atoms, a substituted or unsubstituted aryl group having 6 to 30 carbon atoms, a substituted or unsubstituted amino group, a substituted or unsubstituted alkenyl group having 1 to 20 carbon atoms and a substituted or unsubstituted heterocyclic group. More preferably, Q⁵⁰ to Q⁸⁰ are each a hydrogen atom or a substituted or unsubstituted aryl group having 6 to 30 carbon atoms. In addition, although a structure where Q⁵⁰ and Q⁶⁰ are the same while Q⁷⁰ and Q⁸⁰ are the same is preferable, Q⁵⁰ to Q⁸⁰ may be mutually different. Q¹¹⁰, Q¹²⁰, Q¹³⁰ and Q¹⁴⁰ (collectively referred to as Q¹¹⁰ to Q¹⁴⁰) are each preferably a hydrogen atom.

The alkyl group(s) represented by Q¹⁰ to Q⁴⁰, Q⁵⁰ to Q⁸⁰ and Q¹¹⁰ to Q¹⁴⁰ may be substituted or unsubstituted, or may be linear or branched. Preferable examples of the alkyl group(s) are a methyl group, an ethyl group, an n-propyl group, an isopropyl group, an n-butyl group, a sec-butyl group and a tert-butyl group, n-pentyl group, isopentyl group, neo-pentyl group, tert-pentyl group.

The aryl group(s) represented by Q¹⁰ to Q⁴⁰, Q⁵⁰ to Q⁸⁰ and Q¹¹⁰ to Q¹⁴⁰ may monocyclic or polycyclic, or may be of a condensed-ring structure or of a ring-assembly structure. The aryl group(s) represented by Q¹⁰ to Q⁴⁰, Q⁵⁰ to Q⁸⁰ and Q¹¹⁰ to Q¹⁴⁰ may be substituted or unsubstituted. The aryl group(s) represented by Q¹⁰ to Q⁴⁰, Q⁵⁰ to Q⁸⁰ and Q¹¹⁰ to Q¹⁴⁰ is preferably a phenyl group, an o-tolyl group, an m-tolyl group, a p-tolyl group, a pyrenyl group, a perylenyl group, a coronenyl group, a 1-naphthyl group, a 2-naphthyl group, an anthryl group, an o-biphenyl group, an m-biphenyl group, a p-biphenyl group, a taphenyl group and a phenanthryl group.

Although the amino group(s) represented by Q¹⁰ to Q⁴⁰, Q⁵⁰ to Q⁸⁰ and Q¹¹⁰ to Q¹⁴⁰ may be substituted or unsubstituted, the amino group(s) is preferably substituted and may be an alkylamino group, an arylamino group, an aralkylamino group or the like. The above amino groups each preferably contain fatty series having 1 to 6 carbon atoms in total and/or an aromatic carbon ring having 1 to 4 rings. Examples of such an amino group are a dimethylamino group, a diethylamino group, an abutyl-amino group, a diphenylamino group, a ditolylamino group, a bis-diphenylamino group and a bis-naphtylamino group.

The heterocyclic group(s) represented by Q¹⁰ to Q⁴⁰, Q⁵⁰ to Q⁸⁰ and Q¹¹⁰ to Q¹⁴⁰ may be substituted or unsubstituted. Examples of the heterocyclic group(s) are a five- or six-membered aromatic heterocyclic group containing O, N and S as heteroatoms and a condensed polycyclic aromatic group having 2 to 20 carbon atoms. Examples of the aromatic heterocyclic group and the condensed polycyclic aromatic heterocyclic group are a thienyl group, a furyl group, a pyronyl group, a pyridyl group, a quinolyl group and a quinoxalyl group.

Preferable Examples of the substituted or unsubstituted alkenyl group(s) having 1 to 20 carbon atoms represented by Q¹⁰ to Q⁴⁰, Q⁵⁰ to Q⁸⁰ and Q¹¹⁰ to Q¹⁴⁰ are a 1-phenylalkenyl group, a 2-phenylalkenyl group, 1,2-diphenylalkenyl group, 2,2-diphenylalkenyl group and 1,2,2-triphenylalkenyl group that are each substituted by at least one phenyl group. Each of the above examples may be unsubstituted.

The alkoxy group(s) or the alkylthio group(s) represented by Q¹⁰ to Q⁴⁰, Q⁵⁰ to Q⁸⁰ and Q¹¹⁰ to Q¹⁴⁰ may be substituted or unsubstituted. The alkoxy group(s) or the alkylthio group(s) preferably contains the above-described alkyl group.

The aryloxy group(s) or the arylthio group(s) represented by Q¹⁰ to Q⁴⁰, Q⁵⁰ to Q⁸⁰ and Q¹¹⁰ to Q¹⁴⁰ may be substituted or unsubstituted. The aryloxy group(s) or the arylthio group(s) preferably contains an aryl group. Examples of the aryloxy group(s) are an o-phenoxy group, an m-phenoxy group and a p-phenoxy group while examples of the arylthio group(s) are an o-phenylthio group, an m-phenylthio group and a p-phenylthio group.

The aralkyl group(s) represented by Q¹⁰ to Q⁴⁰, Q⁵⁰ to Q⁸⁰ and Q¹¹⁰ to Q¹⁴⁰ may be substituted or unsubstituted, examples of which are a benzyl group and a phenethyl group.

When Q¹⁰ to Q⁴⁰, Q⁵⁰ to Q⁸⁰, and Q¹¹⁰ to Q¹⁴⁰ are substituted, at least two of the substituents contained, particularly, in Q¹⁰ to Q⁴⁰ are each preferably an aryl group, an amino group, a heterocyclic group, an alkenyl group or an aryloxy group, more preferably an aryl group. The same as described in relation to Q¹⁰ to Q⁴⁰ applies to the aryl group, the amino group, the heterocyclic group and the alkenyl group.

Two or more of the above substituents may form a condensed ring. The above substituents may be further substituted, preferable substituents for which are the same as in the above description.

When Q¹⁰ to Q⁴⁰, Q⁵⁰ to Q⁸⁰, and Q¹¹⁰ to Q¹⁴⁰ are substituted, at least two, particularly, of Q¹⁰ to Q⁴⁰ each preferably contain the above substituent. The substitution positions are not subject to any specific limitations. When Q¹⁰ to Q⁴⁰ contains phenyl, the substitution positions may be any one of meta, para and ortho positions.

In the above formula (1), at least one of Q¹⁰ to Q⁸⁰ is preferably a substituted or unsubstituted aryl group. More preferably, at least one of Q¹⁰ to Q⁴⁰ is a substituted or unsubstituted aryl group.

Specifically, the naphthacene derivative is more preferably represented by the above formula (3).

In the formula (3), Q¹⁰, Q²¹ to Q²⁵, Q³¹ to Q³⁵, Q⁴⁰ to Q⁸⁰ and Q¹¹⁰ to Q¹⁴⁰ each represent a hydrogen atom, a substituted or unsubstituted alkyl group, a substituted or unsubstituted aryl group, a substituted or unsubstituted amino group, a substituted or unsubstituted alkoxy group, a substituted or unsubstituted alkylthio group, a substituted or unsubstituted aryloxy group, a substituted or unsubstituted arylthio group, a substituted or unsubstituted alkenyl group, a substituted or unsubstituted aralkyl group, or a substituted or unsubstituted heterocyclic group. Q¹⁰, Q²¹ to Q²⁵, Q³¹ to Q³⁵, Q⁴⁰ to Q⁸⁰ and Q¹¹⁰ to Q¹⁴⁰ may be mutually the same or different. Adjacent two or more of Q²¹ to Q²⁵ and Q³¹ to Q³⁵ being allowed to be mutually bonded to form a cyclic structure.

The same as described in relation to Q¹⁰ and the like of the formula (1) applies to examples of these groups.

In the formula (3), Q²¹ to Q²⁵ and Q³¹ to Q³⁵ are each preferably selected from a group consisting of a hydrogen group, an aryl group, an amino group, a heterocyclic group, an aryloxy group and an alkenyl group, more preferably an aryl group. In addition, at least one of Q²¹ to Q²⁵ and Q³¹ to Q³⁵ is preferably substituted by an aryl group, an amino group, a heterocyclic group or an aryloxy group, more preferably by an aryl group. Adjacent two or more of the above may form a condensed ring. The same as described in relation to Q¹⁰ to Q⁴⁰ applies to preferable examples of the aryl group, the amino group, the heterocyclic group and the alkenyl group.

In addition, although a structure where Q²¹ to Q²⁵ and Q³¹ to Q³⁵ are the same is preferable, Q²¹ to Q²⁵ may be different from Q³¹ to Q³⁵. Examples of the amino group for substituting Q²¹ to Q²⁵ and Q³¹ to Q³⁵ are an alkylamino group, an arylamino group, an aralkylamino group. The above amino groups each preferably contain fatty series having 1 to 6 carbon atoms in total and/or an aromatic carbon ring having 1 to 4 rings. Examples of such an amino group are a dimethylamino group, a diethylamino group, an abutyl-amino group, a diphenylamino group, a ditolylamino group, a bis-diphenylamino group and a bis-naphtylamino group.

Examples of the condensed ring formed as above are indene, naphthalene, anthracene, phenanthrene, quinoline, isoquinoline, quinoxaline, phenazine, acridine, indole, carbazole, phenoxazine, phenothiazine, benzothiazole, benzothiophen, benzofuran, acridone, benzoimidazole, coumarin and flavone.

Q¹⁰, Q⁴⁰ and Q¹¹⁰ to Q¹⁴⁰ are each particularly preferably a hydrogen atom.

In addition, the substituent(s) for the substituent(s) is preferably an alkyl group, an aryl group or an alkoxy group. The alkyl group is preferably an alkyl group having 1 to 20 carbon atoms, more preferably an alkyl group having 1 to 10 carbon atoms, further preferably an alkyl group having 1 to 5 carbon atoms. The alkyl group may be linear or branched. The alkyl group may be a primary alkyl group, a secondary alkyl group or a tertiary alkyl group. Preferable examples of the alkyl group are a methyl group, an ethyl group, an n-propyl group, an isopropyl group, an n-butyl group, a sec-butyl group, a tert-butyl group, an n-pentyl group, an n-hexyl group, an n-heptyl group, an n-octyl group, an n-nonyl group and an n-decyl group. The aryl group is preferably an aryl group having 6 to 30 carbon atoms, more preferably an aryl group having 6 to 20 carbon atoms. Examples of the aryl group are a phenyl group, a tolyl group, a xylyl group, a phenylphenyl group (4-phenylphenyl group, 3-phenylphenyl group, 2-phenylphenyl group), a naphthylphenyl group (4-(1-naphthyl)phenyl group, 4-(2-naphthyl)phenyl group), a naphthyl group (1-naphthyl group, 2-naphthyl group), a phenylnaphthyl group (6-phenyl-2-naphthyl group, 4-phenyl-1-naphthyl group), a naphthylnaphthyl group (6-naphthyl-2-naphthyl group, 4-naphthyl-1-naphthyl group), an anthranil group, a phenantyl group, a pyrenyl group and a chrysenyl group.

Examples of the aromatic compound represented by the general formula (1) according to the present invention will be shown below. However, the present invention is not limited to the exemplary compounds shown below.

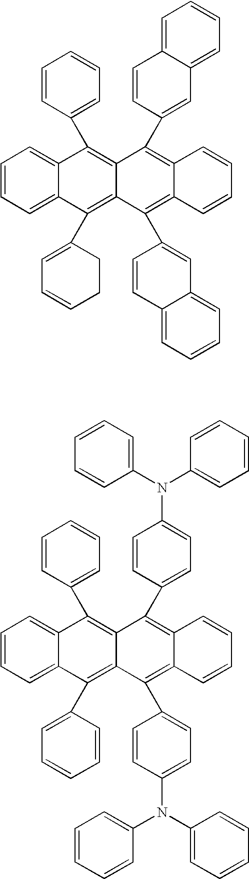

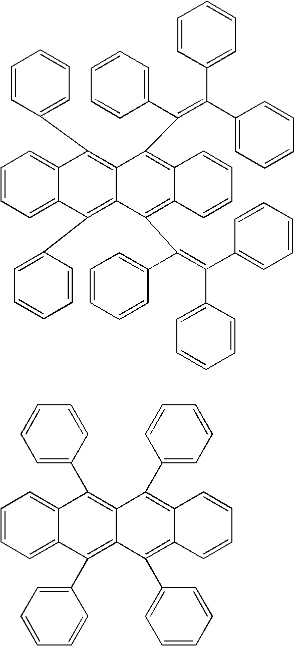

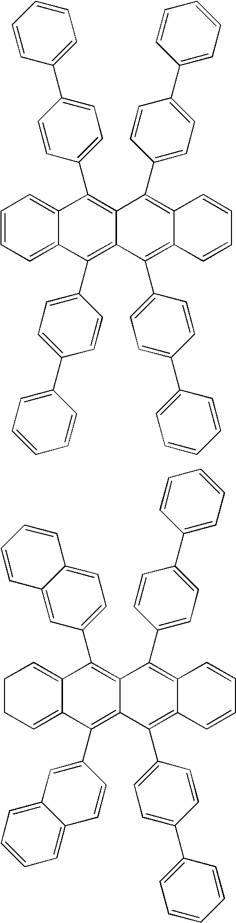

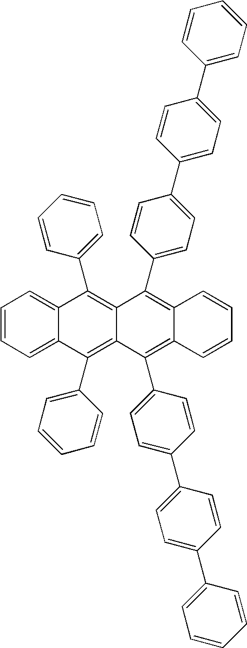

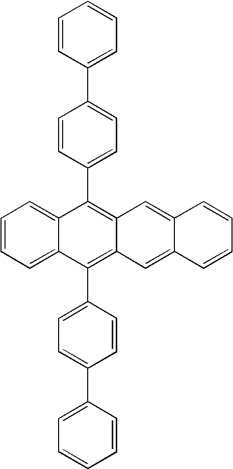

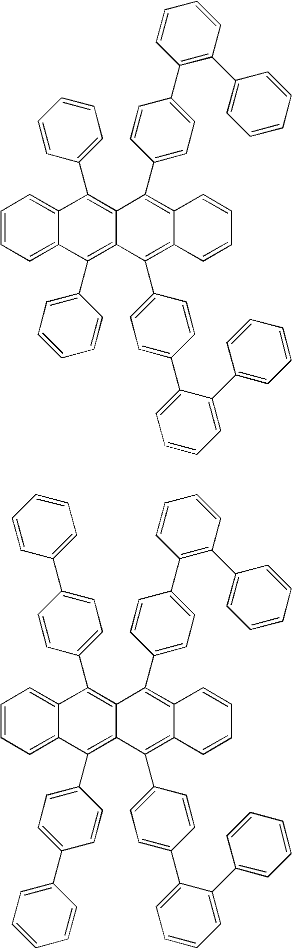

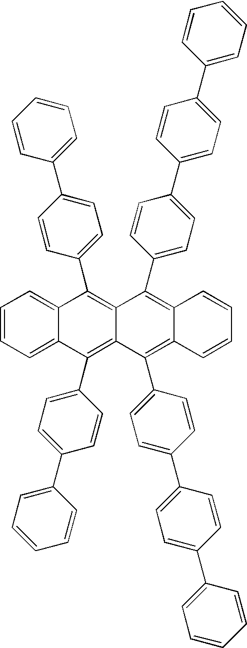

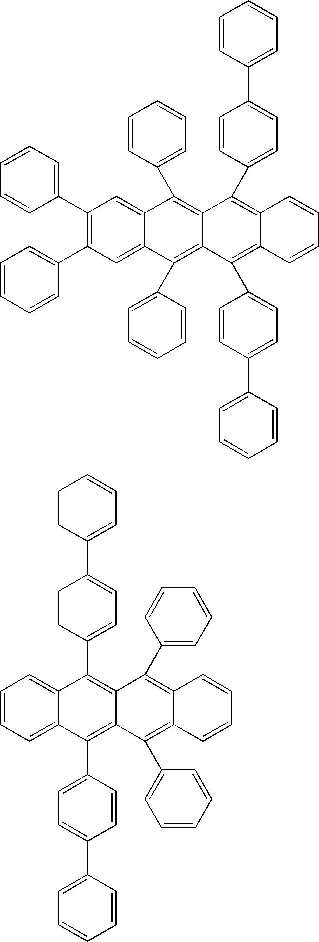

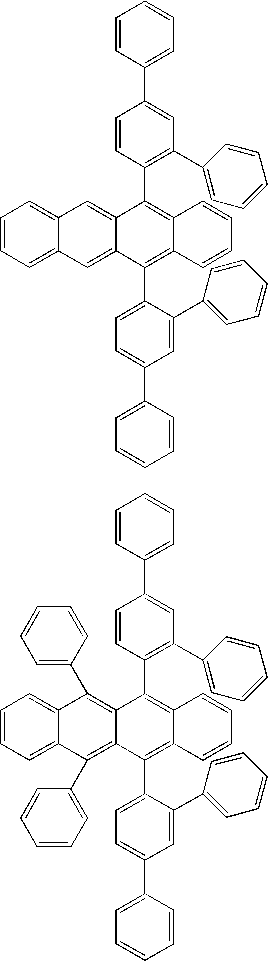

The dopant is a diketopyrolopyrrol derivative represented by the formula (2).

Examples of the alkyl group contained in the structure represented by the formula (2) are a methyl group, an ethyl group, a propyl group, an isopropyl group, a butyl group, a sec-butyl group, a tert-butyl group, a pentyl group, an isopentyl group, a neopentyl group, a tert-pentyl group, a hexyl group, an isohexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group and a benzyl group.

Examples of the alkenyl group contained therein are a vinyl group, a 1-propenyl group, a 2-propenyl group, an isopropenyl group, a 1-butenyl group, a 2-butenyl group, 3-butenyl group, a 1,3-butadienyl group, a 1-pentenyl group, a 2-pentenyl group, a 3-pentenyl group, a 4-pentenyl group and a cinnamyl group.

Examples of the aryl group contained therein are a phenyl group, a biphenyl group, a taphenyl group, a quarterphenyl group, an o-, m- or p-tolyl group, a xylyl group, an o-, m- or p-cumenyl group, a mesityl group, a pentalenyl group, an indenyl group, a naphthyl group, a binaphthalenyl group, a tanaphthalenyl group, a quaternaphthalenyl group, an azulenyl group, a heptalenyl group, biphenylenyl group, an indacenyl group, a fluoranthenyl group, an acenaphthynyl group, an aceanthrylenyl group, a phenalenyl group, a fluorenyl group, an anthryl group, a bianthracenyl group, a taanthracenyl group, a quarteranthracenyl group, an anthraquinolyl group, a phenanthryl group, a triphenylenyl group, a pyrenyl group, a chrysenyl group, a naphthacenyl group, a pleiadenyl group, a picenyl group, a perylenyl group, a pentaphenyl group, a pentacenyl group, a tetraphenylenyl group, a hexaphenyl group, a hexacenyl group, a rubicenyl group, a coronenyl group, a trinaphthylenyl group, a heptaphenyl group, a heptacenyl group, a pyranthrenyl group and an ovalenyl group.

Examples of the heterocyclic group contained therein are a thienyl group, a benzo[b]thienyl group, a naphtho[2,3,-b]thienyl group, a thianthrenyl group, a furyl group, a pyranyl group, an isobenzofuranyl group, a chromenyl group, a xanthenyl group, a phenoxathiinyl group, a 2H-pyrroyl group, a pyrroyl group, an imidazolyl group, a pyrazolyl group, a pyridyl group, a pyrazinyl group, a pyrimidyl group, a pyridazynyl group, an indolizinyl group, an isoindolyl group, a 3H-indolyl group, an indolyl group, a 1H-indazolyl group, a purinyl group, a 4H-quinolizinyl group, an isoquinolyl group, a quinolyl group, a phthalazinyl group, a naphthyridinyl group, a quinoxanilyl group, a quinazolinyl group, a cinnolinyl group, a pteridinyl group, a 4aH-carbazolyl group, a carbazolyl group, a β-carbazolyl group, a phenanthridinyl group, an acridinyl group, a perimidinyl group, a phenanthrolinyl group, a phenazinyl group, a phenarsazinyl group, an isothiazolyl group, a phenothiazinyl group, an isoxazolyl group, a furazanyl group, a phenoxazinyl group, an isochromanyl group, a chromanyl group, a pyrrolidinyl group, a pyrrolinyl group, an imidazolidinyl group, an imidazolinyl group, a pyrazolidinyl group, a pyrazolinyl group, a piperidyl group, a piperazinyl group, an indolinyl group, an isoindolinyl group, a quinuclidinyl group, and a morpholinyl group.

The alkyl group, the alkenyl group, the aryl group or the heterocyclic group above may be further substituted by an alkyl group, an alkenyl group, an aryl group, a heterocyclic group or the like, preferably substituted by an alkyl group or an aryl group.

The alkyl group is preferably an alkyl group having 1 to 20 carbon atoms, more preferably an alkyl group having 1 to 10 carbon atoms, further preferably an alkyl group having 1 to 5 carbon atoms. The alkyl group may be linear or branched. The alkyl group may be a primary alkyl group, a secondary alkyl group or a tertiary alkyl group.

Preferable examples of the alkyl group are a methyl group, an ethyl group, an n-propyl group, an isopropyl group, an n-butyl group, a sec-butyl group, a tert-butyl group, an n-pentyl group, an n-hexyl group, an n-heptyl group, an n-octyl group, an n-nonyl group and an n-decyl group. The aryl group is preferably an aryl group having 6 to 30 carbon atoms, more preferably an aryl group having 6 to 20 carbon atoms. Examples of the aryl group are a phenyl group, a phenylphenyl group (4-phenylphenyl group, 3-phenylphenyl group, 2-phenylphenyl group), a naphthylphenyl group (4-(1-naphthyl)phenyl group, 4-(2-naphthyl)phenyl group), a naphthyl group (1-naphthyl group, 2-naphthyl group), a phenylnaphthyl group (6-phenyl-2-naphthyl group, 4-phenyl-1-naphthyl group), a naphthylnaphthyl group (6-naphthyl-2-naphthyl group, 4-naphthyl-1-naphthyl group), an anthranil group, a phenantyl group, a pyrenyl group and a chrysenyl group.

The above examples can be applied as the aryl group and heterocyclic group represented by each of R⁵ and R⁶. Chemical structural formulae of the above examples will be shown below.

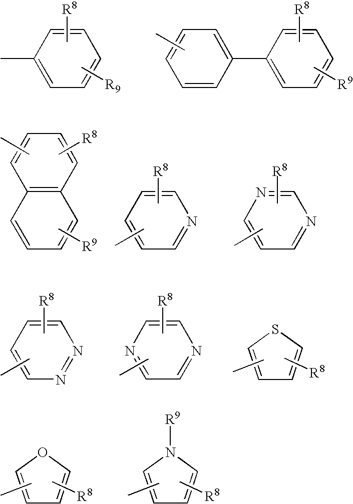

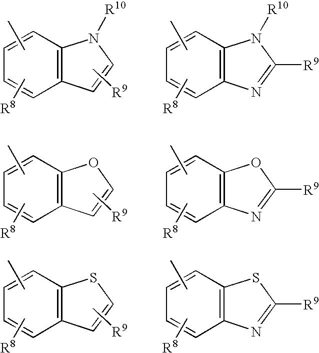

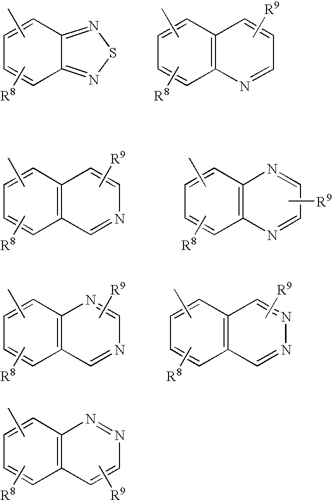

In the formulae, R⁸, R⁹ and R¹⁰ each represent a hydrogen atom, a halogen atom, an alkyl group, an alkoxy group, an alkylthio group, an alkylamino group, an arylamino group, a cyano group, a trifluoromethyl group, an alkenyl group, an aryl group or a heterocyclic group.

The diketopyrrolopyrrole derivative represented by the formula (2) is preferably a diketopyrrolopyrrole derivative represented by the following formula (2-1).

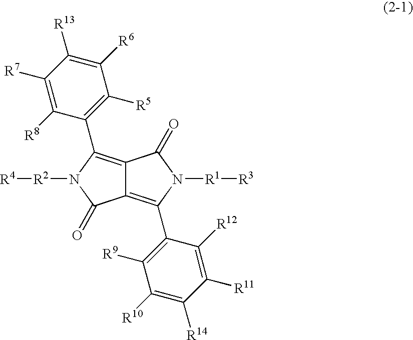

In the formula (2-1), R¹ and R² each represent a substituted or unsubstituted alkylene group, R³ and R⁴ each represent a substituted or unsubstituted aliphatic heterocyclic group or a substituent represented by a formula (2-2) as follows, and R⁵ to R¹⁴ each represent a hydrogen atom or a substituent. At least one of R⁵ to R¹⁴ is an amino group represented by a formula (2-3) as follows,

-X—R¹⁵ (2-2)

In the formula (2-2), X represents an oxygen atom or a sulfur atom, R¹⁵ represents substituted or unsubstituted univalent aliphatic hydrocarbon, substituted or unsubstituted univalent aromatic hydrocarbon or a substituted or unsubstituted univalent aromatic heterocyclic group.

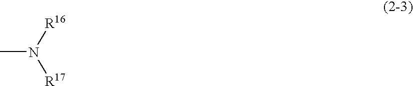

In the formula (2-3), R¹⁶ and R¹⁷ each representing a hydrogen atom, substituted or unsubstituted univalent aliphatic hydrocarbon, substituted or unsubstituted univalent aromatic hydrocarbon or a substituted or unsubstituted univalent aromatic heterocyclic group.

The diketopyrrolopyrrole derivative represented by the formula (2) is preferably a diketopyrrolopyrrole derivative represented by the following formula (2-4).

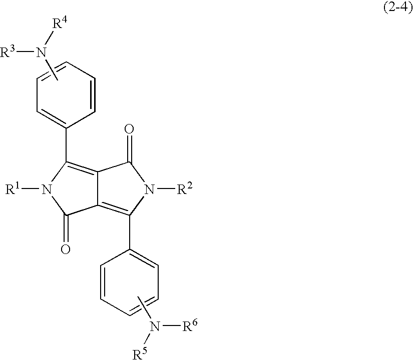

In the formula (2-4), R¹ to R⁶ each represent a substituted or unsubstituted alkyl group, a substituted or unsubstituted aryl group, or a substituted or unsubstituted heterocyclic group.

In the formula (2-4), R¹ and R² each represent a substituted or unsubstituted alkylene group, R³ and R⁴ each represent a substituted or unsubstituted aliphatic heterocyclic group or a substituent represented by a formula (2-5) as follows, R⁵ to R¹² each represent a hydrogen atom or a substituent, and R¹⁸ to R²¹ each represent a hydrogen atom, a substituted or unsubstituted univalent aliphatic hydrocarbon group, a substituted or unsubstituted univalent aromatic hydrocarbon group, or a substituted or unsubstituted univalent aromatic heterocyclic group.

-X—R¹⁵ (2-5)

In the formula (2-5), X represents an oxygen atom or a sulfur atom, R¹⁵ represents substituted or unsubstituted univalent aliphatic hydrocarbon, substituted or unsubstituted univalent aromatic hydrocarbon or a substituted or unsubstituted univalent aromatic heterocyclic group.

The diketopyrrolopyrrole derivative represented by the formula (2) is preferably a diketopyrrolopyrrole derivative represented by the following formula (2-6).

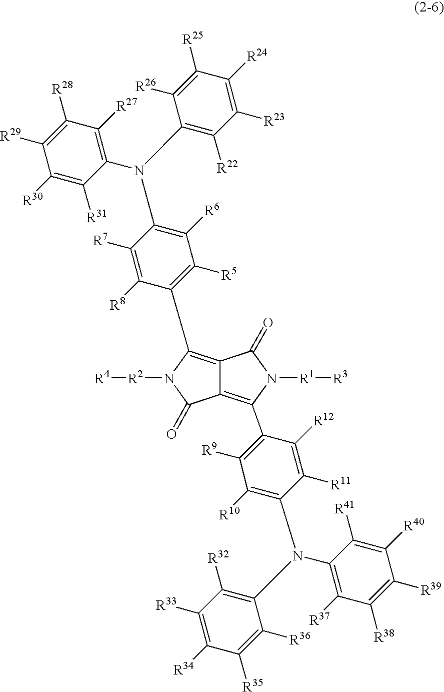

In the formula (2-6), R¹ and R² each represent a substituted or unsubstituted alkylene group, R³ and R⁴ each represent a substituted or unsubstituted aliphatic heterocyclic group or a substituent represented by a formula (2-7) as follows, R⁵ to R¹² each represent a hydrogen atom or a substituent, and R¹ to R² and R²² to R⁴¹ each represent a hydrogen atom or a substituent.

-X—R¹⁵ (2-7)

In the formula (2-7), X represents an oxygen atom or a sulfur atom, and R¹⁵ represents substituted or unsubstituted univalent aliphatic hydrocarbon, substituted or unsubstituted univalent aromatic hydrocarbon or a substituted or unsubstituted univalent aromatic heterocyclic group.

In the diketopyrolopyrrol derivative represented by the formula (2-1), R¹ and R² each represent a substituted or unsubstituted alkylene group, R³ and R⁴ each represent a substituted or unsubstituted aliphatic heterocyclic group or a substituent represented by the formula (2-2), and R⁵ to R¹⁴ each represent a hydrogen atom or a substituent. At least one of R⁵ to R¹⁴ is an amino group represented by the formula (2-3).

Examples of the substituent are a univalent aliphatic hydrocarbon group, a univalent aromatic hydrocarbon group, a halogen atom, an alkoxyl group, an aryloxy group, an alkylthio group, an arylthio group, an acyl group, an alkoxycarbonyl group, an aryloxycarbonyl group, an alkylsulfonyl group, an arylsulfonyl group, a trialkylsilyl group, a cyano group and an amino group.

An example of the alkylene group is an alkylene group having 1 to 10 carbon atoms such as a methylene group, an ethylene group, a propylene group, a butylene group, a sec-butylene group, a tert-butylene group, a pentylene group, a hexylene group, a heptylene group and an octylene group.

An example of the aliphatic heterocyclic group is a univalent aliphatic heterocyclic group having 3 to 18 carbon atoms such as a 1,3-dioxolanyl group, a 1,3-dioxanyl group, a 1,4-dioxanyl group, a 2-tetrahydrofuryl group, a 2-monopholino group, a 4-monopholino group and a piperidino group.

An example of the univalent aliphatic hydrocarbon group is a univalent aliphatic hydrocarbon group having 1 to 18 carbon atoms such as an alkyl group, an alkenyl group, an alkynyl group and a cycloalkyl group.

An example of the alkylene group is an alkyl group having 1 to 18 carbon atoms such as a methyl group, an ethyl group, a propyl group, an isopropyl group, a butyl group, an isobutyl group, a sec-butyl group, a tert-butyl group, a pentyl group, an isopentyl group, a hexyl group, a heptyl group, an octyl group, a decyl group, a todecyl group, a pentadecyl group and an octadecyl group.

An example of the alkenyl group is an alkenyl group having 2 to 18 carbon atoms such as a vinyl group, a 1-propenyl group, a 2-propenyl group, an isopropenyl group, a 1-butenyl group, a 2-butenyl group, a 3-butenyl group, a 1-octenyl group, a 1-decenyl group and 1-octadecenyl group.

An example of the alkynyl group is an alkynyl group having 2 to 18 carbon atoms such as an ethynyl group, a 1-propynyl group, a 2-propynyl group, a 1-butynyl group, a 2-butynyl group, a 3-butynyl group, a 1-octynyl group, a 1-decynyl group and an 1-octadecynyl group.

An example of the cycloalkyl group is a cycloalkyl group having 3 to 18 carbon atoms such as a cyclopropyl group, a cyclobutyl group, a cyclopentyl group, a cyclohexyl group, a cycloheptyl group, a cyclooctyl group, a cyclooctadecyl group, a 2-boronyl group, a 2-isobornyl group and a 1-adamantyl group.

Examples of the univalent aromatic hydrocarbon group are a univalent monocyclic aromatic hydrocarbon group having 6 to 30 carbon atoms, a univalent condensed-ring aromatic hydrocarbon group having 6 to 30 carbon atoms and a univalent ring-assembly aromatic hydrocarbon group having 6 to 30 carbon atoms. Examples of the univalent monocyclic aromatic hydrocarbon group having 6 to 30 carbon atoms are a phenyl group, an o-tolyl group, an m-tolyl group, a p-tolyl group, a 2,4-xylyl group, a p-cumenyl group and a mesityl group.

An example of the univalent condensed-ring aromatic hydrocarbon group is a univalent condensed-ring hydrocarbon group having 10 to 30 carbon atoms such as a 1-naphthyl group, a 2-naphthyl group, a 1-anthryl group, a 2-anthryl group, a 5-anthryl group, a 1-phenanthryl group, a 9-phenanthryl group, a 1-acenaphthyl group, a 2-azulenyl group, a 1-pyrenyl group, a 2-triphenylel group, a 1-pyrenyl group, a 2-pyrenyl group, a 1-perylenyl group, a 2-perylenyl group, a 3-perylenyl group, a 2-triphenylenyl group, a 2-indenyl group, a 1-acenaphthylenyl group, a 2-naphthacenyl group and a 2-pentacenyl group.

An example of the univalent ring-assembly aromatic hydrocarbon group is a univalent ring-assembly hydrocarbon group having 12 to 30 carbon atoms such as an o-biphenylyl group, an m-biphenylyl group, a p-biphenylyl group, a terphenylyl group and a 7-(2-naphthyl)-2-naphthyl group.

An example of the univalent aromatic heterocyclic group is a univalent aromatic heterocyclic group having 3 to 30 carbon atoms such as a 2-furyl group, a 3-furyl group, a 2-thienyl group, a 3-thienyl group, an N-pyrroyl group, a 2-benzofuryl group, a 2-benzothienyl group, a 2-pylozyl group, a 3-pyridyl group, a 4-pyridyl group, a 2-quinolyl group and a 5-isoquinolyl group.

Examples of the halogen atom are a fluorine atom, a chlorine atom and a bromine atom.

An example of the alkoxyl group is an alkoxyl group having 1 to 18 carbon atoms such as a methoxy group, an ethoxy group, a propoxy group, a butoxy group, a tert-butoxy group, an octyloxy group, a tert-octyloxy group, a 2-bornyloxy group, a 2-isobornyloxy group and a 1-adamantyloxy group.

An example of the aryloxy group is an aryloxy group having 6 to 30 carbon atoms such as a phenoxy group, a 4-tert-butylphenoxy group, a 1-naphthyloxy group, a 2-naphthyloxy group and a 9-anthryloxy group.

An example of the alkylthio group is an alkylthio group having 1 to 18 carbon atoms such as a methylthio group, an ethylthio group, a tert-butylthio group, a hexylthio group and an octylthio group.

An example of the arylthio group is an arylthio group having 6 to 30 carbon atoms such as a phenylthio group, a 2-methylphenylthio group and a 4-tert-butylphenylthio group.

An example of the acyl group is an acyl group having 2 to 18 carbon atoms such as an acetyl group, a propionyl group, a pivaloyl group, a cyclohexylcarbonyl group, a benzoyl group, a toloyl group, an anisoyl group and a cinnamoyl group.

An example of the alkoxycarbonyl group is an alkoxycarbonyl group having 2 to 18 carbon atoms such as a methoxycarbonyl group, an ethoxycarbonyl group and a benzyloxycarbonyl group.

An example of the aryloxycarbonyl group is an aryloxycarbonyl group having 7 to 30 carbon atoms such as a phenoxycarbonyl group and a naphthyloxycarbonyl group.

An example of the alkylsulfonyl group is an alkylsulfonyl group having 1 to 18 carbon atoms such as a mesyl group, an ethylsulfonyl group and an propylsulfonyl group.

An example of the arylsulfonyl group is an arylsulfonyl group having 6 to 30 carbon atoms such as a benzenesulfonyl group and a p-toluenesulfonyl group.

An example of the trialkylsilyl group is a trialkylsilyl group having 6 to 18 carbon atoms such as a trimethylsilyl group, a triethylsilyl group, a dimethylethylsilyl group, a triisopropylsilyl group and a tributylsilyl group.

An example of the amino group is an amino group having 6 to 30 carbon atoms such as a diethylamino group, a dibutylamino group, a diphenylamino group, a ditolylamino group and an ethylphenyl amino group.

These substituents may be further substituted by other substituents, or may be bonded together to form a ring.

In the formula (2-2), R¹⁵ represents substituted or unsubstituted univalent aliphatic hydrocarbon, substituted or unsubstituted univalent aromatic hydrocarbon or a substituted or unsubstituted univalent aromatic heterocyclic group. The univalent aliphatic hydrocarbon group, the univalent aromatic hydrocarbon group and the univalent aromatic heterocyclic group are the same as the univalent aliphatic hydrocarbon group, the univalent aromatic hydrocarbon group and the univalent aromatic heterocyclic group in the structure represented by the formula (2-1).

In the formula (2-3), R¹⁶ and R¹⁷ each represent a hydrogen atom, substituted or unsubstituted univalent aliphatic hydrocarbon, substituted or unsubstituted univalent aromatic hydrocarbon or a substituted or unsubstituted univalent aromatic heterocyclic group. The univalent aliphatic hydrocarbon group, the univalent aromatic hydrocarbon group and the univalent aromatic heterocyclic group are the same as the univalent aliphatic hydrocarbon group, the univalent aromatic hydrocarbon group and the univalent aromatic heterocyclic group in the structure represented by the formula (2-1).

In the formula (2-4), R¹⁸ to R²¹ each represent a hydrogen atom, a substituted or unsubstituted univalent aliphatic hydrocarbon group, a substituted or unsubstituted univalent aromatic hydrocarbon group, or a substituted or unsubstituted univalent aromatic heterocyclic group. The univalent aliphatic hydrocarbon group, the univalent aromatic hydrocarbon group and the univalent aromatic heterocyclic group are the same as the univalent aliphatic hydrocarbon group, the univalent aromatic hydrocarbon group and the univalent aromatic heterocyclic group in the structure represented by the formula (2-1).

In the formula (2-6), R²² to R⁴¹ each represent a hydrogen atom or a substituent. The substituent is the same as the substituent in the formula (2-1), examples of which are a univalent aliphatic hydrocarbon group, a univalent aromatic hydrocarbon group, a univalent aliphatic heterocyclic group, a univalent aromatic heterocyclic group, a halogen atom, an alkoxyl group, an aryloxy group, an alkylthio group, an arylthio group, an acyl group, an alkoxycarbonyl group, an aryloxycarbonyl group, an alkylsulfonyl group, an arylsulfonyl group, a trialkylsilyl group, a cyano group and an amino group.

The substituent represented by each of R¹ to R⁴¹ preferably has 1 to 18 carbon atoms, more preferably 1 to 12 carbon atoms because the device may not be favorably manufactured by deposition when the substituent(s) has too many carbon atoms.

The diketopyrolopyrrol compound preferably has a molecular weight of 2,000 or less, more preferably 1,500 or less, further preferably 1,000 or less because the device may not be favorably manufactured by deposition when the compound has a large molecular weight.

Examples of the diketopyrolopyrrol compound represented by the general formula (2) according to the present invention will be shown below. However, the present invention is not limited to the exemplary compounds shown below.

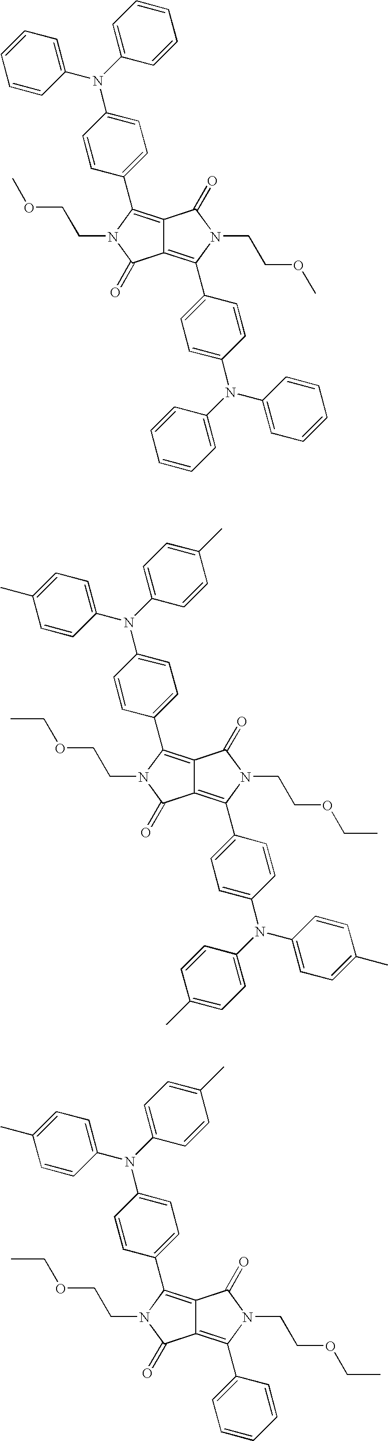

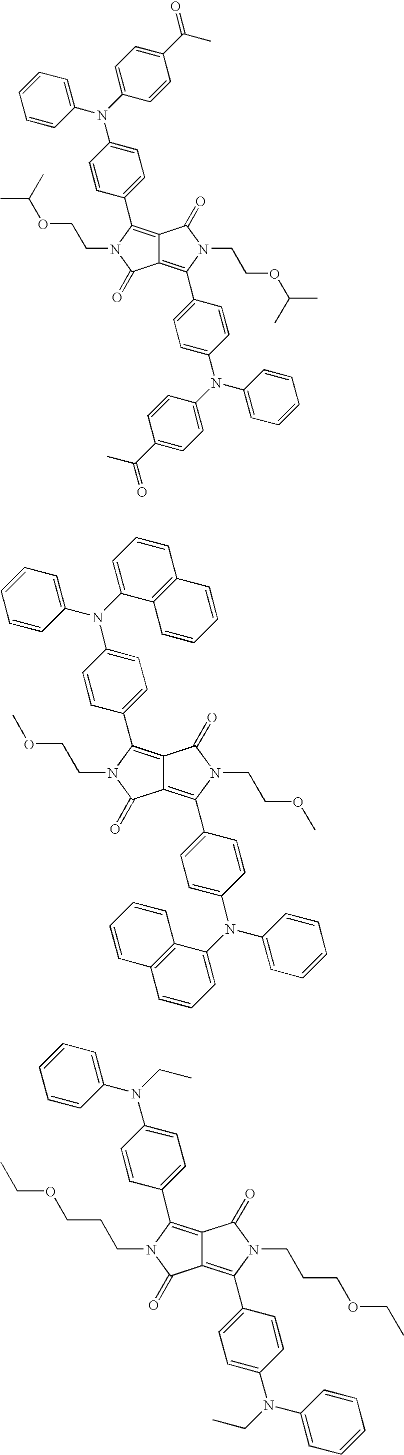

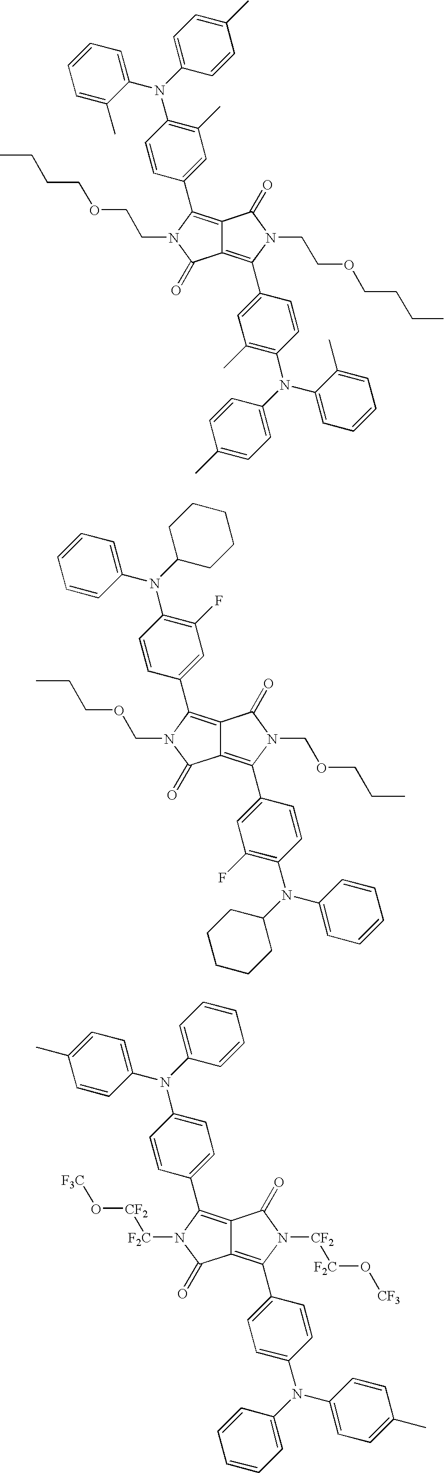

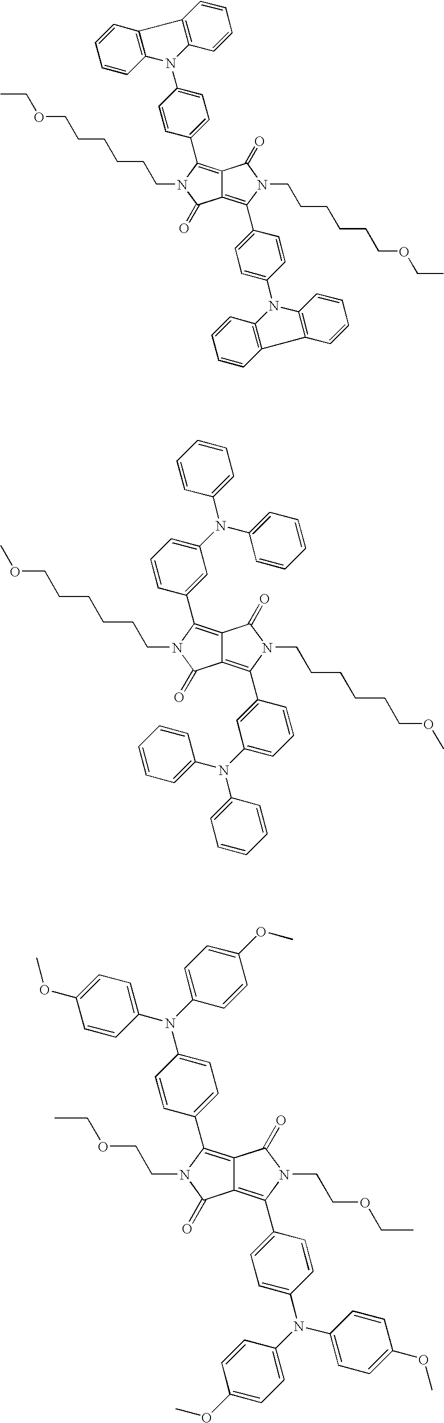

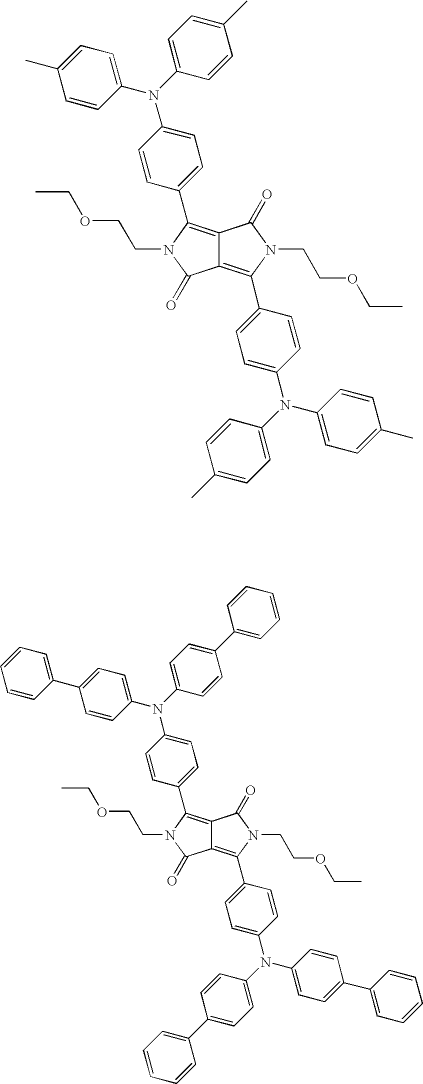

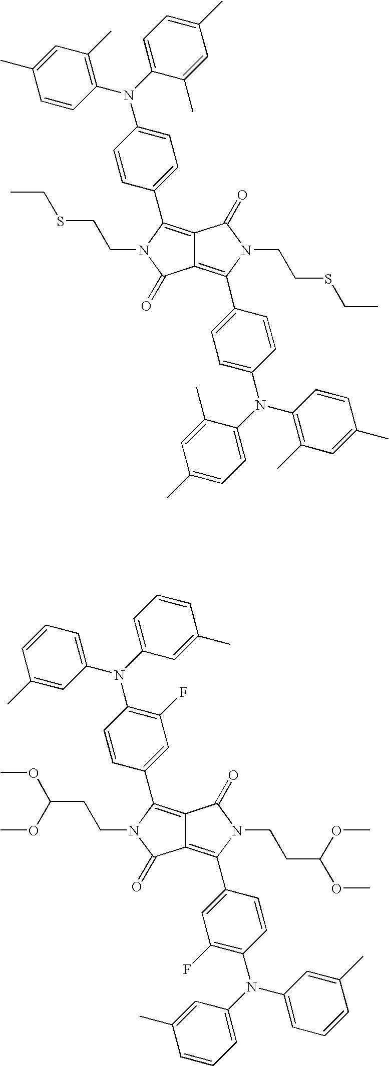

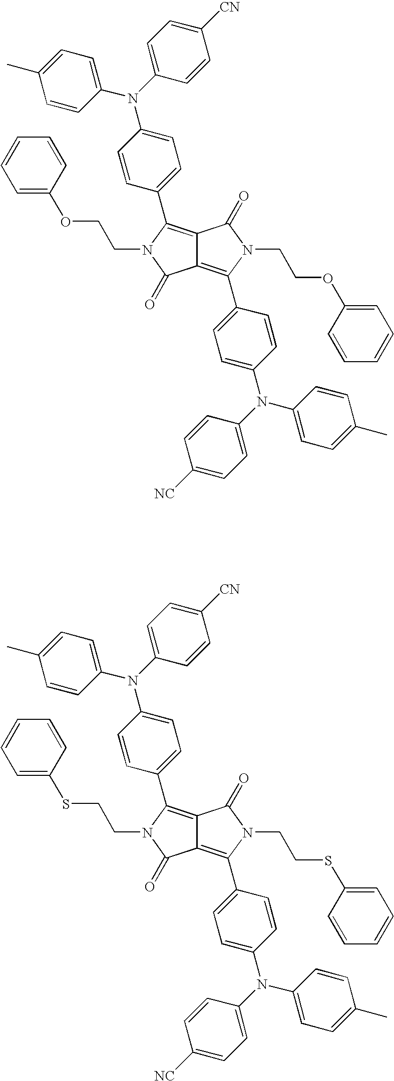

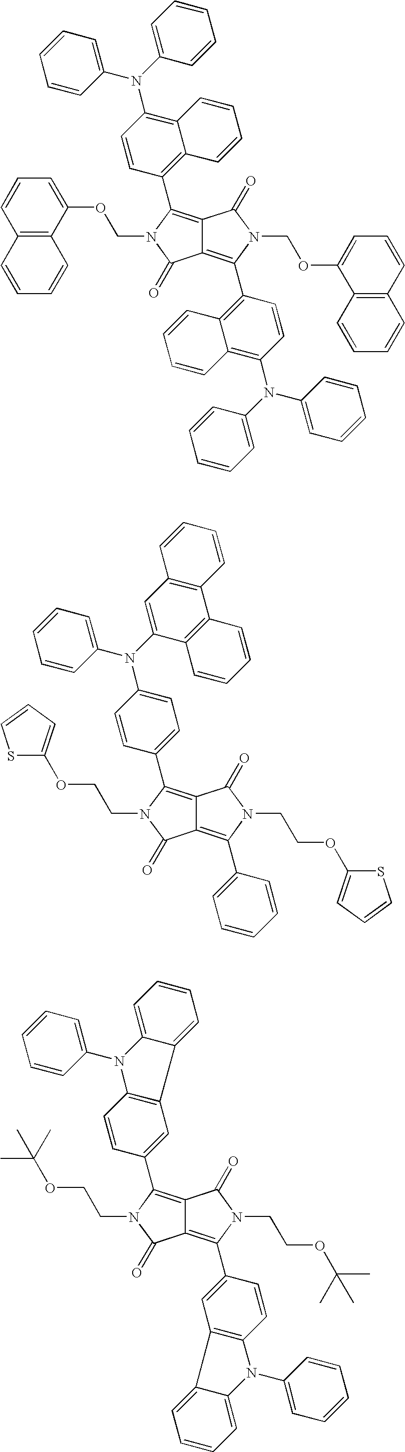

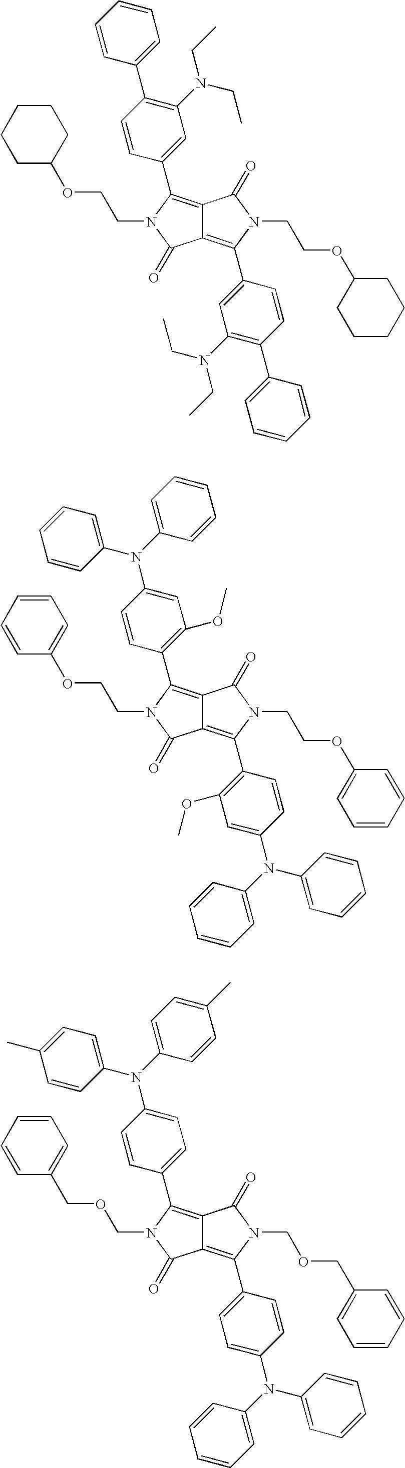

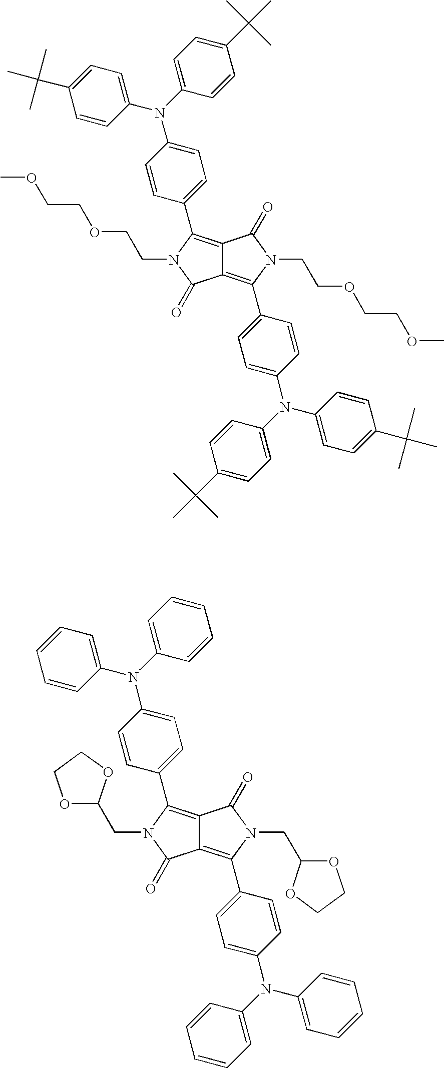

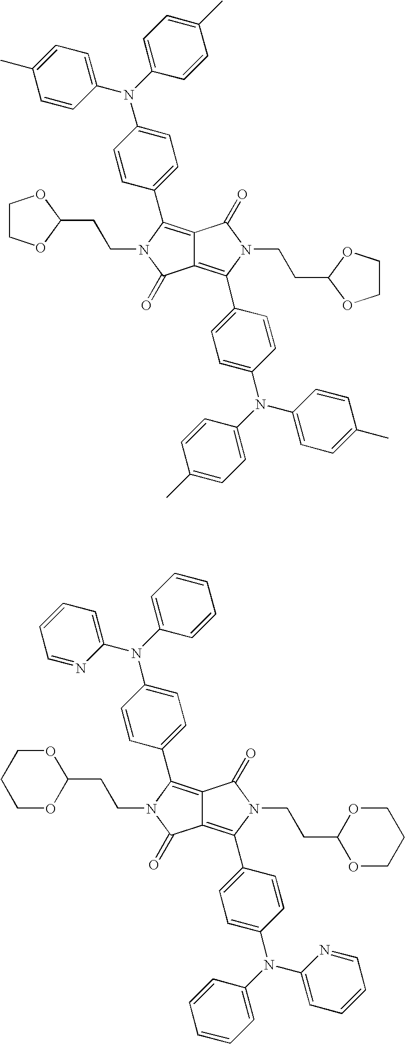

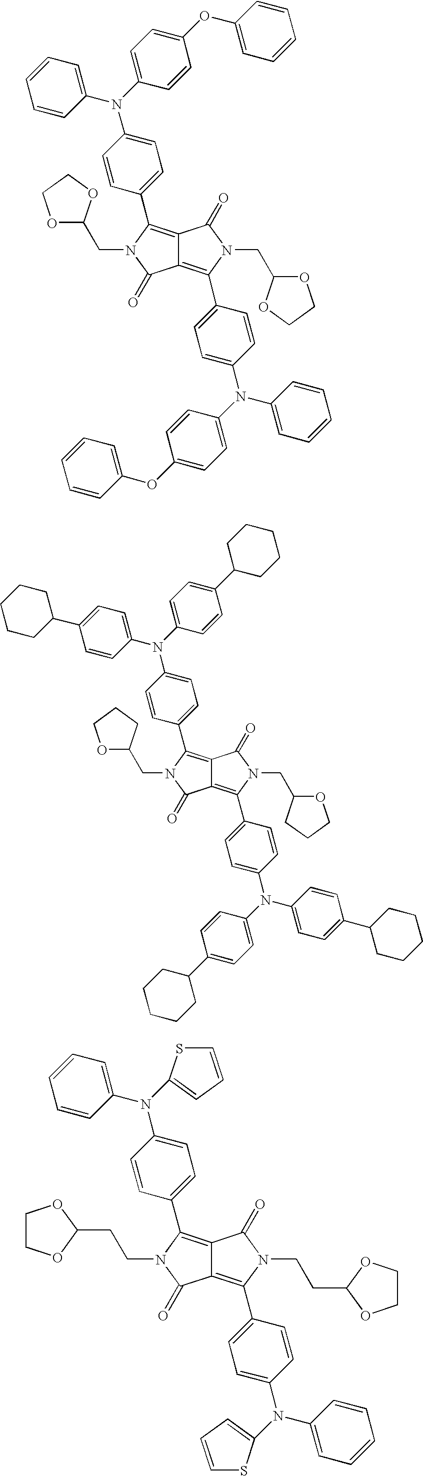

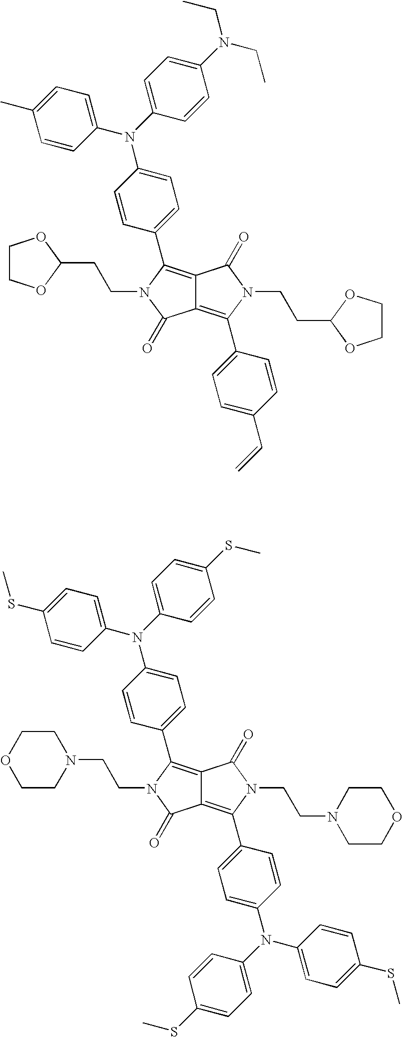

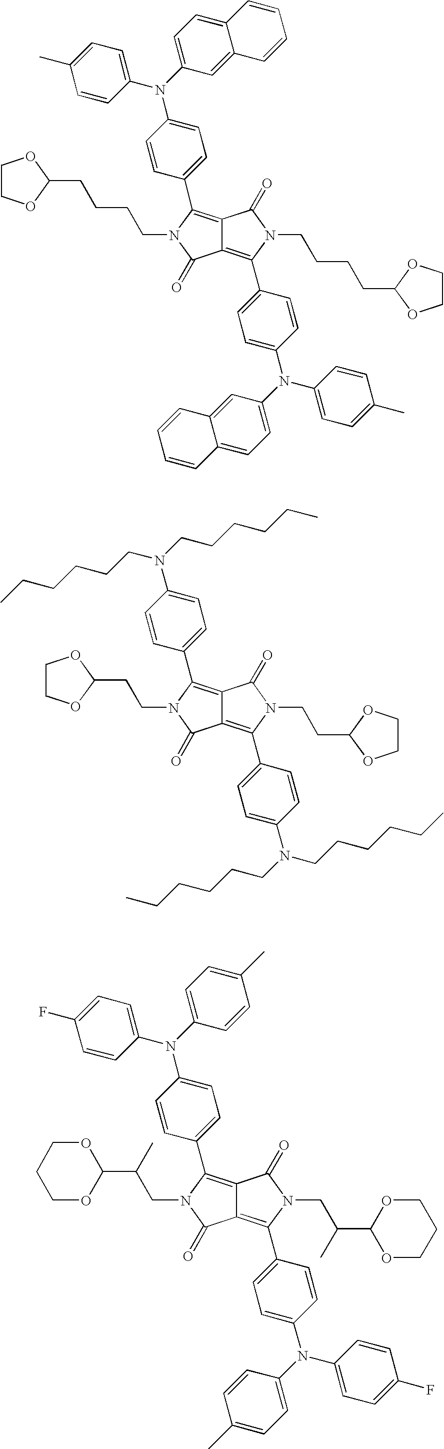

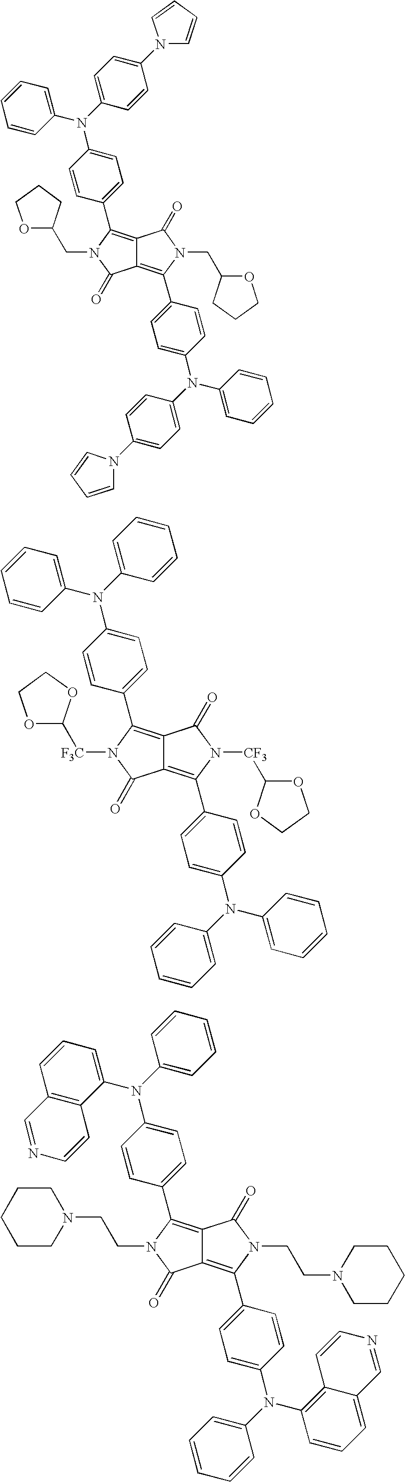

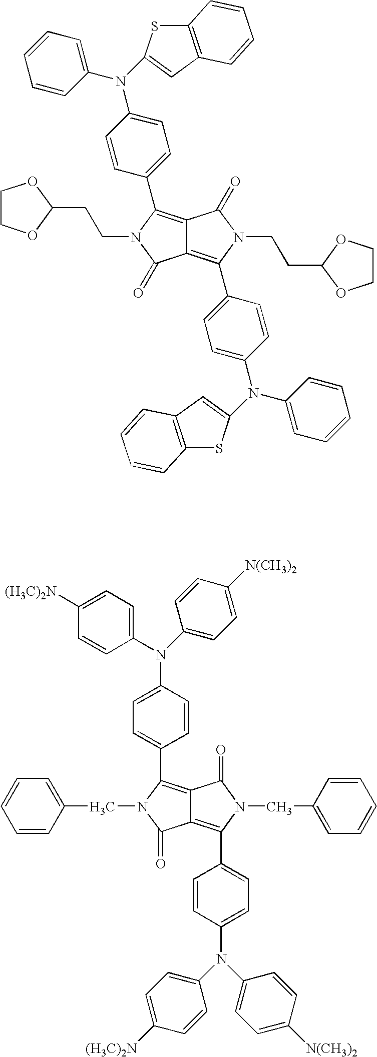

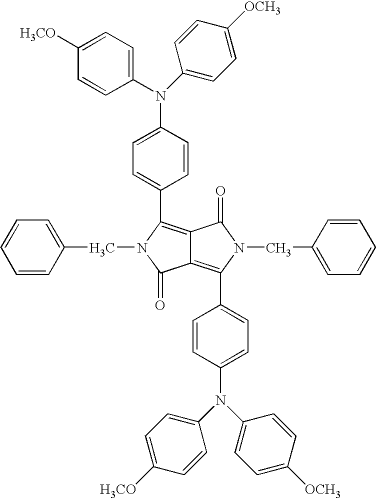

### [Hole Transporting Layer and Hole Injecting Layer]

The hole transporting layer helps injection of the holes into the emitting layer and transports the holes to an emitting region, in which the hole mobility is large and the energy of ionization is typically small (5.5 eV or smaller). A material of the hole transporting layer is preferably such a material that transports the holes to the emitting layer with a low field intensity, and more preferably such a material that transports the holes with the hole mobility of at least 10⁻⁴ cm² V*sec when the exemplary electrical field of 10⁴ to 10⁶ V/cm is applied.

A material for the hole transporting layer is not specifically limited as long as the material has the above preferable characteristics. Any materials conventionally used for transporting charges of the holes in photoconducting materials or any materials publicly known to be applicable to the hole transporting layers of the EL devices may be used.

Examples of the material are a triazole derivative (see, for instance, the specification of U.S. Pat. No. 3,112,197), an oxadiazole derivative (see, for instance, the specification of U.S. Pat. No. 3,189,447), an imidazole derivative (see, for instance, the publication of JP-B-37-16096), a polyarylalkane derivative (see, for instance, the specifications of U.S. Pat. No. 3,615,402, No. 3,820,989 and No. 3,542,544 and the publications of JP-B-45-555, JP-B-51-10983, JP-A-51-93224, JP-A-55-17105, JP-A-56-4148, JP-A-55-108667, JP-A-55-156953, and JP-A-56-36656), a pyrazoline derivative and a pyrazolone derivative (see, for instance, the specifications of U.S. Pat. No. 3,180,729 and No. 4,278,746 and the publications of JP-A-55-88064, JP-A-55-88065, JP-49-105537, JP-A-55-51086, JP-A-56-80051, JP-A-56-88141, JP-A-57-45545, JP-A-54-112637 and JP-A-55-74546, a phenylenediamine derivative (see, for instance, the specification of U.S. Pat. No. 3,615,404 and the publications of JP-B-51-10105, JP-B-46-3712, JP-B-47-25336 and JP-A-54-119925), an arylamine derivative (see, for instance, the specifications of U.S. Pat. No. 3,567,450, No. 3,240,597, No. 3,658,520, No. 4,232,103, No. 4,175,961 and No. 4,012,376 and the publications of JP-B-49-35702, JP-B-39-27577, JP-A-55-144250, JP-A-56-119132 and JP-A-56-22437 and the specification of West Germany Patent No. 1,110,518), an amino-substituted chalcone derivative (see, for instance, the specification of U.S. Pat. No. 3,526,501), an oxazole derivative (disclosed in, for instance, the specification of U.S. Pat. No. 3,257,203), a styrylanthracene derivative (see, for instance, the publication of JP-A-56-46234), a fluorenone derivative (see, for instance, the publication of JP-A-54-110837), a hydrazone derivative (see, for instance, the specification of U.S. Pat. No. 3,717,462 and the publications of JP-A-54-59143, JP-A-55-52063, JP-A-55-52064, JP-A-55-46760, JP-A-57-11350, JP-A-57-148749 and JP-A-2-311591), a stilbene derivative (see, for instance, the publications of JP-A-61-210363, JP-A-61-228451, JP-A-61-14642, JP-A-61-72255, JP-A-62-47646, JP-A-62-36674, JP-A-62-10652, JP-A-62-30255, JP-A-60-93455, JP-A-60-94462, JP-A-60-174749 and JP-A-60-175052), a silazane derivative (see the specification of U.S. Pat. No. 4,950,950), a polysilane type (see the publication of JP-A-2-204996), an aniline-based copolymer (see the publication of JP-A-02-282263), and a conductive high-molecular oligomer (particularly, thiophene oligomer).

Preferably, a material represented by the following formula (7) may be used.

Q¹-G-Q² (7)

In the formula (7), Q¹ and Q² each represent a portion having at least one tertiary amine while G represents a linking group.

More preferable material is an amine derivative represented by the following formula (8).

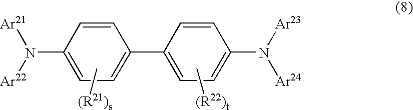

In the above formula (8), Ar²¹ to Ar²⁴ each represent a substituted or unsubstituted aromatic ring having 6 to 50 carbon atoms forming the ring or a substituted or unsubstituted heteroaromatic ring having 5 to 50 atoms forming the ring. R²¹ and R²² each represent a substituent while s and t each represent an integer in a range of 0 to 4. Ar²¹ and Ar²² may be bonded together to form a cyclic structure while Ar²³ and Ar²⁴ may also be bonded together to form a cyclic structure. R²¹ and R²² may also be bonded together to form a cyclic structure.

The substituent for Ar²¹ to Ar²⁴ each, and R²¹ and R²² are selected from a group consisting of a substituted or unsubstituted aromatic ring having 6 to 50 carbon atoms forming the ring, a substituted or unsubstituted heteroaromatic ring having 5 to 50 atoms forming the ring, an alkyl group having 1 to 50 carbon atoms, an alkoxy group having 1 to 50 carbon atoms, an alkylaryl group having 1 to 50 carbon atoms, an aralkyl group having 1 to 50 carbon atoms, a styryl group, an amino group substituted by an aromatic ring having 6 to 50 carbon atoms forming the ring or by a heteroaromatic ring having 5 to 50 atoms forming the ring, an aromatic ring having 6 to 50 carbon atoms forming the ring substituted by an amino group substituted by an aromatic ring having 6 to 50 carbon atoms forming the ring or by a heteroaromatic ring having 5 to 50 atoms forming the ring, and a heteroaromatic ring having 5 to 50 atoms forming the ring substituted by an amino group substituted by an aromatic ring having 6 to 50 carbon atoms forming the ring or by a heteroaromatic ring having 5 to 50 atoms forming the ring.

In order to aid the injection of the holes, a hole injecting layer may be provided in addition to the hole transporting layer. The above materials for the hole transporting layer can be used as the materials of the hole injecting layer, preferable examples of which are a porphyrin compound (disclosed in JP-A-63-295665), an aromatic tertiary amine compound and a styrylamine compound (see, for instance, the specification of U.S. Pat. No. 4,127,412, JP-A-53-27033, JP-A-54-58445, JP-A-55-79450, JP-A-55-144250, JP-A-56-119132, JP-A-61-29558, JP-A-61-98353 and JP-A-63-295695). Among these, use of an aromatic tertiary amine compound is particularly preferable.

In addition, 4,4′-bis(N-(1-naphthyl)-N-phenylamino)biphenyl (hereinafter, abbreviated as NPD) having in the molecule two condensed aromatic rings disclosed in U.S. Pat. No. 5,061,569, 4,4′,4″-tris(N-3-methylphenyl-N-phenylamino)triphenylamine (hereinafter, abbreviated as MTDATA) in which three triphenylamine units disclosed in JP-A-04-30868 are bonded in a starbust form and the like may also be used.

As another example, a nitrogen-containing heterocyclic derivative represented by the following formula (9), which is disclosed in Japanese Patent No. 03571977, may be used.

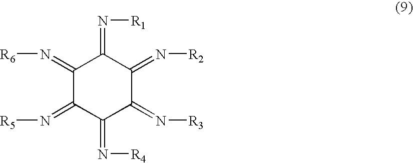

In the formula (9), R¹ to R⁶ each represent a substituted or unsubstituted alkyl group, a substituted or unsubstituted aryl group, a substituted or unsubstituted aralkyl group, or a substituted or unsubstituted heterocyclic group. R₁ to R₆ may be mutually the same or different. A pair of R₁ and R₂, a pair of R₃ and R₄ or a pair of R₅ and R₆ may form a condensed ring(s). Alternatively, a pair of R₁ and R₆, a pair of R₂ and R₃ or a pair of R₄ and R₅ may form a condensed ring(s).

As another example, a compound represented by the following formula (10), which is disclosed in US 2004/113547A1, may be used.

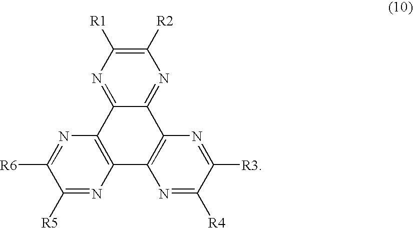

In the formula (10), R1 to R6 each represent a substituent, a preferable example of which is an electron-attracting group such as a cyano group, a nitro group, a sulfonyl group, a carbonyl group, a trifluoromethyl group and a halogen.

In addition to aromatic dimethylidyne-based compounds, inorganic compounds such as p-type Si and p-type SiC can be used as the material of the hole injecting layer.

The hole injecting layer and the hole transporting layer can be formed by forming thin films from the compounds listed above by known methods such as vacuum deposition, spin coating, casting and the LB method. Although the thickness of the hole injecting layer and the hole transporting layer is not particularly limited, the thickness is typically in the range from 5 nm to 5 μm. The hole injecting layer and the hole transporting layer may be formed by a single layer formed of at least one of the above materials as long as the hole injecting layer and the hole transporting layer each contain the above compound(s) in the hole transporting zone. Alternatively, the hole injecting layer and the hole transporting layer may be formed by laminating layers respectively formed of a different material.

In addition, an organic semiconductor layer, which is a part of the hole transporting layer, aids the injection of the holes or the electrons into the emitting layer. The organic semiconductor layer preferably has electric conductivity of 10⁻¹⁰ S/cm or more. Examples of a material for the organic semiconductor layer are a conductive oligomer such as a thiophene-containing oligomer or an arylamine-containing oligomer (disclosed in JP-A-08-193191), and a conductive dendrimer such as an arylamine-containing dendrimer.

### [Electron Injecting/Transporting Layers (Electron Transport Zone)]

The electron transporting layer, which aids injection of the electrons into the emitting layer, has a high electron mobility. The thickness of the electron transporting layer is suitably selected from the range of several nanometers to several micrometers. However, especially when the thickness of the electron transporting layer is large, the electron mobility, in order to prevent voltage from rising, is preferably at least 10⁻⁵ cm²/Vs or higher with the electrical field of 10⁴ to 10⁶ V/cm applied.

The electron transporting layer preferably contains a compound represented by any one of the following formulae (4), (5) and (6).

In the formulae (5) and (6), R represents a hydrogen atom, a substituted or unsubstituted aryl group having 6 to 60 carbon atoms, a substituted or unsubstituted pyridyl group, substituted or unsubstituted quinolyl group, a substituted or unsubstituted alkyl group having 1 to 20 carbon atoms, or a substituted or unsubstituted alkoxy group having 1 to 20 carbon atoms while p represents an integer in a range of 1 to 4.

Preferable examples of the aryl group having 6 to 60 carbon atoms are a phenyl group, 1-naphthyl group, 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, p-ta-phenyl-4-yl group, p-ta-phenyl-3-yl group, p-ta-phenyl-2-yl group, m-ta-phenyl-4-yl group, m-ta-phenyl-3-yl group, m-ta-phenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenylyl group, 4″-t-butyl-p-ta-phenyl-4-yl group, fluoranthenyl group and fluorenyl group. More preferable examples thereof are a phenyl group, naphthyl group, biphenyl group, anthracenyl group, phenanthryl group, pyrenyl group, chrysenyl group, fluoranthenyl group and fluorenyl group.

Preferable examples of the alkyl group having 1 to 20 carbon atoms are a methyl group, ethyl group, propyl group, isopropyl group, n-butyl group, s-butyl group, isobutyl group, t-butyl group, n-pentyl group, n-hexyl group, n-heptyl group, n-octyl group, hydroxymethyl group, 1-hydroxyethyl group, 2-hydroxyethyl group, 2-hydroxyisobutyl group, 1,2-dihydroroxyethyl group, 1,3-dihydroxyisopropyl group, 2,3-dihydroxy-t-butyl group, 1,2,3-trihydroxypropyl group, chloromethyl group, 1-chloroethyl group, 2-chloroethyl group, 2-chloroisobutyl group, 1,2-dichloroethyl group, 1,3-dichloroisopropyl group, 2,3-dichloro-t-butyl group, 1,2,3-trichloropropyl group, bromomethyl group, 1-bromoethyl group, 2-bromoethyl group, 2-bromoisobuthyl group, 1,2-dibromoethyl group, 1,3-dibromoisopropyl group, 2,3-dibromo-t-butyl group, 1,2,3-tribromopropyl group, iodomethyl group, 1-iodoethyl group, 2-iodoethyl group, 2-iodoisobutyl group, 1,2-diiodoethyl group, 1,3-diiodoisopropyl group, 2,3-diiodo-t-butyl group, 1,2,3-triiodopropyl group, aminomethyl group, 1-aminoethyl group, 2-aminoethyl group, 2-aminoisobutyl group, 1,2-diaminoethyl group, 1,3-diaminoisopropyl group, 2,3-diamino-t-butyl group, 1,2,3-triaminopropyl group, cyanomethyl group, 1-cyanoethyl group, 2-cyanoethyl group, 2-cyanoisobutyl group, 1,2-dicyanoethyl group, 1,3-dicyanoisopropyl group, 2,3-dicyano-t-butyl group, 1,2,3-tricyanopropyl group, nitromethyl group, 1-nitroethyl group, 2-nitroethyl group, 2-nitroisobutyl group, 1,2-dinitroethyl group, 1,3-dinitroisopropyl group, 2,3-dinitro-t-butyl group, 1,2,3-trinitropropyl group, cyclopropyl group, cyclobutyl group, cyclopentyl group, cyclohexyl group, 4-methylcyclohexyl group, 1-adamantyl group, 2-adamantyl group, 1-norbornyl group and 2-norbornyl group.

The alkoxy group having 1 to 20 carbon atoms is a group represented by —OY′″. Examples of Y′″ are the same as those of the above alkyl group.

Examples of the substituent for each of the aryl group, the pyridyl group, the quinolyl group, the alkyl group or the alkoxy group are a substituted or unsubstituted aryl group having 6 to 50 carbon atoms forming the ring, a substituted or unsubstituted aromatic heterocyclic group having 5 to 50 atoms forming the ring, a substituted or unsubstituted alkyl group having 1 to 50 carbon atoms, a substituted or unsubstituted alkoxy group having 1 to 50 carbon atoms, a substituted or unsubstituted aralkyl group having 1 to 50 carbon atoms, a substituted or unsubstituted aryloxy group having 5 to 50 atoms forming the ring, a substituted or unsubstituted arylthio group having 5 to 50 atoms forming the ring, a substituted or unsubstituted carboxyl group having 1 to 50 carbon atoms, a halogen group, a cyano group, a nitro group and a hydroxyl group.

In the formulae (5) and (6), p represents an integer in a range of 1 to 4. Preferably, p is any one of 1 to 3, more preferably 1 or 2.

R preferably represents a hydrogen atom.

R¹¹ represents a substituted or unsubstituted aryl group having 6 to 60 carbon atoms, a substituted or unsubstituted pyridyl group, a substituted or unsubstituted quinolyl group, a substituted or unsubstituted alkyl group having 1 to 20 carbon atoms or an alkoxy group having 1 to 20 carbon atoms. Examples of each group and substituent are the same as R.

R¹² represents a hydrogen atom, a substituted or unsubstituted aryl group having 6 to 60 carbon atoms, a substituted or unsubstituted pyridyl group, a substituted or unsubstituted quinolyl group, a substituted or unsubstituted alkyl group having 1 to 20 carbon atoms or a substituted or unsubstituted alkoxy group having 1 to 20 carbon atoms. Examples of each group and substituent are the same as R.

L represents a substituted or unsubstituted arylene group having 6 to 60 carbon atoms, a substituted or unsubstituted pyridinylene group, a substituted or unsubstituted quinolinylene group, or a substituted or unsubstituted fluorenylene group.

Preferable examples of the arylene group having 6 to 60 carbon atoms are divalent substituents formed by further removing one hydrogen atom from the substituents listed in the description of the aryl group having 6 to 60 carbon atoms. More preferable examples thereof are a phenylene group, naphthylene group, biphenylene group, anthracenylene group, phenantolylene group, pyrenylene group, chrysenylene group, fluoranthenylene group and fluorenylene group.

Examples of the substituent for each of the arylene group, the pyridinylene group, the quinolinylene group or the fluorenylene group are the same as R.

Ar¹ represents a substituted or unsubstituted aryl group having 6 to 60 carbon atoms (preferably, 6 to 30 carbon atoms), a substituted or unsubstituted pyridyl group or a substituted or unsubstituted quinolyl group.

Examples of the substituent for each of the aryl group having 6 to 60 carbon atoms, the aryl group, the pyridyl group or the quinolyl group are the same as R.

Preferably in the benzoimidazole derivative represented by the formula (5): R represents a hydrogen atom; R″ represents an aryl group; L represents an arylene group having 6 to 30 carbon atoms (preferably, 6 to 20 carbon atoms); and Ar¹ represents an aryl group having 6 to 30 carbon atoms.

Preferably in the benzoimidazole derivative represented by the formula (6): R represents a hydrogen atom; R¹² represents an aryl group; L represents an arylene group having 6 to 30 carbon atoms (preferably, 6 to 20 carbon atoms); and Ar¹ represents an aryl group having 6 to 30 carbon atoms.

Although the compound(s) represented by the formulae (4), (5) and (6) are preferably applicable to the electron transporting layer, the material of the electron transporting layer is not limited thereto. Compounds containing 8-hydroxyquinoline, a metal complex of its derivative, or a nitrogen-containing heterocycle may be preferably applicable to the electron transporting layer.

An example of the 8-hydroxyquinoline or the metal complex of its derivative is a metal chelate oxinoid compound containing a chelate of oxine (typically 8-quinolinol or 8-hydroxyquinoline). For example, an Alq complex having Al as its central metal can be used for the electron transporting layer.

On the other hand, examples of the oxadiazole derivative are electron transporting compounds represented by the following general formulae.

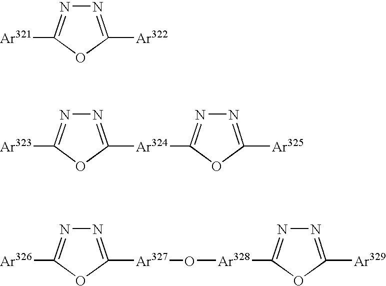

In the formulae, Ar³²¹, Ar³²², Ar³²³, Ar³²⁵, Ar³²⁶ and Ar³²⁹ each represent a substituted or unsubstituted aryl group, which may be mutually the same or different. Ar³²⁴, Ar³²⁷ and Ar³²⁸ each represent a substituted or unsubstituted arylene group, which may be mutually the same or different.

Examples of the aryl group are a phenyl group, a biphenyl group, an anthranil group, a perylenyl group, and a pyrenyl group. Examples of the arylene group are a phenylene group, a naphthylene group, a biphenylene group, an anthranylene group, a perylenylene group and a pyrenylene group. Examples of the substituent therefor are an alkyl group having 1 to 10 carbon atoms, an alkoxy group having 1 to 10 carbon atoms or a cyano group. The electron transporting compounds are preferably compounds that exhibit favorable performance in forming a thin film.

Examples of the electron transporting compounds are as follows.

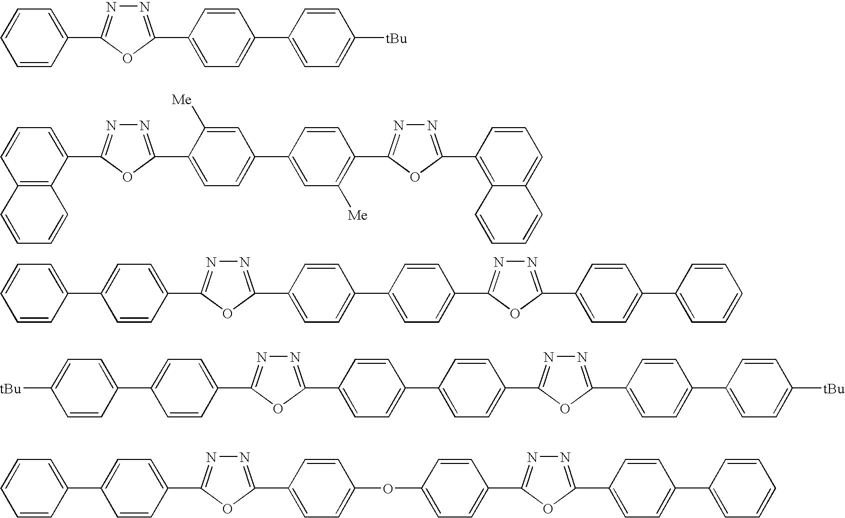

Me represents a methyl group while Bu represents a butyl group.

A silacyclopentadiene derivative represented by the following formula (disclosed in JP-A-09-087616) is also preferably applicable to the electron transporting layer.

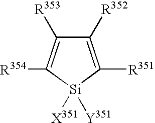

In the formula, X³⁵¹ and Y³⁵¹ may each represent a saturated or unsaturated hydrocarbon group having 1 to 6 carbon atoms, an alkoxy group, an alkenyloxy group, an alkynyloxy group, a hydroxy group, a substituted or unsubstituted aryl group or a substituted or unsubstituted heterocycle, or X³⁵¹ and Y³⁵ may be bonded together to form a saturated or unsaturated ring. R³⁵¹ to R³¹⁴ may each represent hydrogen, halogen, a substituted or unsubstituted alkyl group having 1 to 6 carbon atoms, an alkoxy group, an aryloxy group, a perfluoroalkyl group, a perfluoroalkoxy group, an amino group, an alkylcarbonyl group, an arylcarbonyl group, an alkoxycarbonyl group, an aryloxycarbonyl group, an azo group, an alkylcarbonyloxy group, an arylcarbonyloxy group, an alkoxycarbonyloxy group, an aryloxycarbonyloxy group, a sulfinyl group, a sulfonyl group, a sulfanyl group, a silyl group, a carbamoyl group, an aryl group, a heterocyclic group, an alkenyl group, an alkynyl group, a nitro group, a formyl group, a nitroso group, a formyloxy group, an isocyano group, a cyanate group, an isocyanate group, a thiocyanate group, an isothiocyanate group or cyano group, or an adjacent set of R³⁵¹ to R³⁵⁴ may be condensed to form a substituted or unsubstituted ring.

A silacyclopentadiene derivative represented by the following formula (disclosed in JP-A-09-194487) is also preferably applicable to the electron transporting layer.

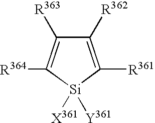

In the formula, X³⁶¹ and Y³⁶¹ may each represent a saturated or unsaturated hydrocarbon group having 1 to 6 carbon atoms, an alkoxy group, an alkenyloxy group, an alkynyloxy group, a substituted or unsubstituted aryl group or a substituted or unsubstituted heterocycle, or X³⁶¹ and Y³⁶¹ may be bonded together to form a saturated or unsaturated ring. R³⁶¹ to R³⁶⁴ may each represent hydrogen, halogen, a substituted or unsubstituted alkyl group having 1 to 6 carbon atoms, an alkoxy group, an aryloxy group, a perfluoroalkyl group, a perfluoroalkoxy group, an amino group, an alkylcarbonyl group, an arylcarbonyl group, an alkoxycarbonyl group, an aryloxycarbonyl group, an azo group, an alkylcarbonyloxy group, an arylcarbonyloxy group, an alkoxycarbonyloxy group, an aryloxycarbonyloxy group, a sulfinyl group, a sulfonyl group, a sulfanyl group, a silyl group, a carbamoyl group, an aryl group, a heterocyclic group, an alkenyl group, an alkynyl group, a nitro group, a formyl group, a nitroso group, a formyloxy group, an isocyano group, a cyanate group, an isocyanate group, a thiocyanate group, an isothiocyanate group or cyano group, or an adjacent set of R³⁶¹ to R³⁶⁴ may be condensed to form a substituted or unsubstituted ring. However, when R³⁶¹ and R³⁶⁴ are phenyl groups, neither X³⁶¹ nor Y³⁶¹ is an alkyl group or a phenyl group. When R³⁶¹ and R³⁶⁴ are thienyl groups, X³⁶¹ and Y³⁶¹ are each a univalent hydrocarbon group provided that neither R³⁶² nor R³⁶³ is an alkyl group, an aryl group or an alkenyl group, and that a pair of R³⁶² and R³⁶³ does not form an aliphatic group by bonding together to form the ring thereof. When R³⁶¹ and R³⁶⁴ are silyl groups, none of R³⁶², R³⁶³, X³⁶¹ and Y³⁶¹ is a univalent hydrocarbon group having 1 to 6 carbon atoms or a hydrogen atom. When R³⁶¹ and R³⁶² are of a condensed benzene-ring structure, neither of X³⁶¹ nor Y³⁶¹ is an alkyl group or a phenyl group.

A borane derivative represented by the following formula (disclosed in JP-A1-2000-040586) is also preferably applicable to the electron transporting layer.

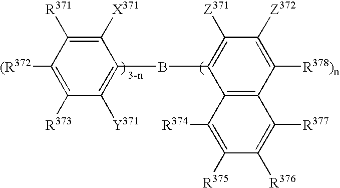

In the formula, R³⁷¹ to R³⁷⁸ and Z³⁷² each represent a hydrogen atom, a saturated or unsaturated hydrocarbon group, an aromatic group, a heterocyclic group, a substituted amino group, a substituted boryl group, an alkoxy group or an aryloxy group; X³⁷¹, Y³⁷¹ and Z³⁷¹ each represent a saturated or unsaturated hydrocarbon group, an aromatic group, a heterocyclic group, a substituted amino group, an alkoxy group or an aryloxy group; substituents for Z³⁷¹ and Z³⁷² may be bonded to form a condensed ring; and n represents an integer in a range of 1 to 3. When n is equal to or larger than 2, Z³⁷¹ may be mutually different. However, the above does not apply when: n is 1; X³⁷¹, Y³⁷¹ and R³⁷² are the methyl groups; and R³⁷⁸ is the hydrogen atom or the substituted boryl group, or when: n is 3; and Z³⁷¹ is the methyl group.

A compound represented by the following formula (disclosed in JP-A-10-088121) is also preferably applicable to the electron transporting layer.

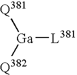

In this formula, Q³⁸¹ and Q³⁸² each represent a ligand shown by the formula below. L³⁸¹ represents a ligand which may be a halogen atom, a substituted or unsubstituted alkyl group, a substituted or unsubstituted cycloalkyl group, a substituted or unsubstituted aryl group, a substituted or unsubstituted heterocyclic group, or L³⁸¹ represents a ligend represented by —OR³⁹¹ (R³⁹¹ representing a hydrogen atom, a substituted or unsubstituted alkyl group, a substituted or unsubstituted cycloalkyl group, a substituted or unsubstituted aryl group or a substituted or unsubstituted heterocyclic group) or a ligend represented by —O—Ga-Q³⁹¹(Q³⁹²) (Q³⁹¹ and Q³⁹² being the same as Q³⁸¹ and Q³⁸²).

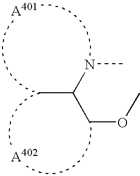

In the above formula, rings A⁴⁰¹ and A⁴⁰² are bonded together to form a substituted or unsubstituted aryl ring or a heterocycle.

Examples of the substituent groups of the ring A⁴⁰¹ and the ring A⁴⁰² that form the ligands in the formula above are: halogen atoms such as chlorine, bromine, iodine and fluorine; substituted or unsubstituted alkyl groups such as a methyl group, an ethyl group, a propyl group, a butyl group, a sec-butyl group, a tert-butyl group, a pentyl group, a hexyl group, a heptyl group, an octyl group, a stearyl group and a trichloromethyl group; substituted or unsubstituted aryl groups such as a phenyl group, a naphthyl group a 3-methylphenyl group, a 3-methoxyphenyl group, a 3-fluorophenyl group, a 3-trichloromethylphenyl group, a 3-trifluoromethylphenyl group and a 3-nitrophenyl group; substituted or unsubstituted alkoxy groups such as a methoxy group, a n-butoxy group, a tert-butoxy group, a trichloromethoxy group, a trifluoroethoxy group, a pentafluoropropoxy group, a 2,2,3,3-tetrafluoropropoxy group, a 1,1,1,3,3,3-hexafluoro-2-propoxy group and a 6-(perfluorohethyl)hexyloxy group; substituted or unsubstituted aryloxy groups such as a phenoxy group, a p-nitrophenoxy group, a p-tert-butylphenoxy group, a 3-fluorophenoxy group, a pentafluorophenyl group and a 3-trifluoromethylphenoxy group; substituted or unsubstituted alkylthio groups such as a methylthio group, an ethylthio group, a tert-butylthio group, a hexylthio group, an octylthio group and a trifluoromethylthio group; substituted or unsubstituted arylthio groups such as a phenylthio group, a p-nitrophenylthio group, a p-tert-butylphenylthio group, a 3-fluorophenylthio group, a pentafluorophenylthio group and a 3-trifluoromethylphenylthio group; mono- or disubstituted amino groups such as a cyano group, a nitro group, an amino group, a methylamino group, a diethylamino group, an ethylamino group, a diethylamino group, a dipropylamino group, a dibutylamino group and a diphenylamino group; acylamino groups such as a bis(acetoxymethyl)amino group, a bis(acetoxyethyl)amino group, a bis(acetoxypropyl)amino group and a bis(acetoxybutyl)amino group; a hydroxyl group; a siloxy group; an acyl group; carbamoyl groups such as a methylcarbamoyl group, a dimethylcarbamoyl group, an ethylcarbamoyl group, a diethylcarbamoyl group, a propylcarbamoyl group, a butylcarbamoyl group, and a phenylcarbamoyl group; a carboxylic acid group; a sulfonic acid group; an imide group; cycloalkyl groups such as a cyclopentane group and a cyclohexyl group; aryl groups such as a phenyl group, a naphthyl group, a biphenyl group, an anthranil group, a phenanthryl group, a fluorenyl group and a pyrenyl group; and heterocyclic groups such as a pyridyl group, a pyrazinyl group, a pyrimidinyl group, a pyridazinyl group, a triazinyl group, an indolinyl group, a quinolyl group, an acridinyl group, a pyrrolidinyl group, a dioxanyl group, a piperidinyl group, a morpholidinyl group, a piperazinyl group, a carbazolyl group, a furanyl group, a thiophenyl group, an oxazolyl group, an oxadiazolyl group, a benzoxazolyl group, a thiazolyl group, a thiadiazolyl group, a benzothiazolyl group, a triazolyl group, an imidazolyl group and a benzoimidazolyl group. In addition, the substituent groups listed above may be bonded together to form a 6-membered aryl ring or a heterocycle.

As a preferred embodiment of the organic EL device according to the present invention, there is known a device containing a reductive dopant at a boundary between a region transporting the electrons or the cathode and an organic layer. The reductive dopant is defined as a substance capable of reducing an electron transporting compound. Thus, various substances having a certain level of reducibility can be used, preferable examples of which are at least one substance selected from a group consisting of: alkali metal, alkali earth metal, rare earth metal, an oxide of the alkali metal, a halogenide of the alkali metal, an oxide of the alkali earth metal, a halogenide of the alkali earth metal, an oxide of the rare earth metal, a halogenide of the rare earth metal, an organic complex of the alkali metal, an organic complex of the alkali earth metal and an organic complex of the rare earth metal.

Specifically, the reductive dopant is preferably a substance(s) having the work function of 2.9 eV or lower, which is exemplified by at least one alkali metal selected from a group consisting of Na (work function: 2.36 eV), K (work function: 2.28 eV), Rb (work function: 2.16 eV) and Cs (work function: 1.95 eV) or at least one alkali earth metal selected from a group consisting of Ca (work function: 2.9 eV), Sr (work function: 2 to 2.5 eV) and Ba (work function: 2.52 eV). Among these, the reductive dopant is more preferably at least one alkali metal selected from a group consisting of K, Rb and Cs, among which Rb and Cs are even more preferable and Cs is the most preferable. These alkali metals have particularly high reducibility, so that addition of a relatively small amount of these alkali metals to an electron injecting zone can enhance luminescence intensity and lifecycle of the organic electroluminescence device. In addition, as the reductive dopant having the work function of 2.9 eV or lower, a combination of two or more of these alkali metals is also preferable, and a combination including Cs is particularly preferable (e.g. combinations of Cs and Na, Cs and K, Cs and Rb or Cs, Na and K). The combinations including Cs can effectively exert the reducibility, so that the addition of such reductive dopant to the electron injecting zone can enhance the luminescence intensity and the lifecycle of the organic electroluminescence device.

According to the present invention, an electron injecting layer formed from an insulator or a semiconductor may be provided between the cathode and the organic layer. With the arrangement, leak of electric current can be effectively prevented and the electron injecting capability can be enhanced. As the insulator, it is preferable to use at least one metal compound selected from a group consisting of an alkali metal chalcogenide, an alkali earth metal chalcogenide, a halogenide of alkali metal and a halogenide of alkali earth metal. By forming the electron injecting layer from the alkali metal chalcogenide or the like, the electron injecting capability can preferably be further enhanced. Specifically, preferable examples of the alkali metal chalcogenide are Li₂O, LiO, Na₂S, Na₂Se and NaO, while preferable example of the alkali earth metal chalcogenide are CaO, BaO, SrO, BeO, BaS and CaSe. Preferable examples of the halogenide of the alkali metal are LiF, NaF, KF, LiCl, KCl and NaCl. Preferable examples of the halogenide of the alkali earth metal are fluorides such as CaF₂, BaF₂, SrF₂, MgF₂ and BeF₂, and halogenides other than the fluoride.

Examples of the semiconductor for forming the electron injecting layer are one of or a combination of two or more of an oxide, a nitride or an oxidized nitride containing at least one element selected from a group consisting of Ba, Ca, Sr, Yb, Al, Ga, In, Li, Na, Cd, Mg, Si, Ta, Sb and Zn. An inorganic compound for forming the electron injecting layer is preferably a microcrystalline or amorphous semiconductor film. When the electron injecting layer is formed of such semiconductor film, more uniform thin film can be formed, thereby reducing pixel defects such as a dark spot. Examples of such an inorganic compound are the above-described alkali metal chalcogenide, alkali earth metal chalcogenide, halogenide of the alkali metal and halogenide of the alkali earth metal.

### [Cathode]

In order to inject the electrons into the electron injecting and transporting layers or the emitting layer, a material whose work function is small (4 eV or lower) is used as an electrode material for the cathode, examples of the material being metals, alloys, electrically conductive compounds and mixtures thereof. Examples of the electrode material are sodium, a sodium-potassium alloy, magnesium, lithium, a magnesium-silver alloy, aluminium/aluminium oxide, an aluminium-lithium alloy, indium, rare earth metal and the like.

The cathode is made by forming a thin film from the electrode material by vapor deposition and sputtering.

When the organic EL device is top-emission type, the cathode preferably transmits more than 10% of light emitted by the emitting layer.

The sheet resistance as the cathode is preferably several hundreds Ω/square or lower, and the thickness of the film is typically in a range from 10 nm to 1 im, preferably 50 to 200 nm.

### [Insulating Layer]

Since the electrical field is applied to ultra thin films in the organic electroluminescence device, pixel defects resulted from leak or short circuit are likely to occur. In order to prevent such defects, it is preferable to interpose an insulating thin film layer between a pair of electrodes.

Examples of a material used for the insulating layer are aluminum oxide, lithium fluoride, lithium oxide, cesium fluoride, cesium oxide, magnesium oxide, magnesium fluoride, calcium oxide, calcium fluoride, cesium fluoride, cesium carbonate, aluminium nitride, titanium oxide, silicon oxide, germanium oxide, silicon nitride, boron nitride, molybdenum oxide, ruthenium oxide, vanadium oxide and the like.

Mixtures or laminates thereof may also be used.

### [Manufacturing Example(s) of Organic EL Device]

The organic EL device can be manufactured by forming the anode, the emitting layer and the cathode (in addition to the above, forming the hole injecting layer, the hole transporting layer, the electron injecting layer and the electron transporting layer as necessary) from the materials listed above by the above-described formation methods. The organic EL device can also be manufactured by forming the above elements in the inverse order of the above, namely from the cathode to the anode.

The following is a manufacturing example of the organic EL device in which the anode, the hole transporting layer, the emitting layer, the electron transporting layer and the cathode are sequentially formed on the light-transmissive substrate.

A thin film is formed of the anode material on a suitable light-transmissive substrate by vapor deposition or sputtering such that the thickness of the thin film is 1 μM or smaller, preferably in a range from 10 nm to 200 nm, thereby forming the anode. Then, the hole transporting layer is formed on the formed anode. The hole transporting layer may be formed by a method such as vacuum deposition, spin coating, casting and the LB method as described above, among which vacuum deposition is preferable in forming the hole transporting layer because the method can easily form homogeneous films and can prevent generation of pin holes. When the hole transporting layer is formed by vacuum deposition, conditions for conducting vacuum deposition depend on the compounds to be used (i.e., the material of the hole transporting layer), a crystal structure of the targeted hole transporting layer, and a recombination structure of the targeted hole transporting layer. Generally, conditions are preferably set so as to satisfy deposition-source temperature of 50 to 450 degrees C., vacuum of 10⁻⁷ to 10⁻³ torr, deposition speed of 0.01 to 50 nm/second, substrate temperature of −50 to 300 degrees C., film thickness of 5 nm to 5 μm.

Then, the emitting layer is formed on the hole transporting layer. The emitting layer may also be formed of a desirable material by a method such as vacuum deposition, sputtering, spin coating and casting, among which vacuum deposition is preferable in forming the emitting layer because the method can easily form homogeneous films and can prevent generation of pin holes. When the emitting layer is formed by vacuum deposition, deposition conditions for forming the emitting layer can be generally set in the same manner as the hole transporting layer although the deposition conditions may vary depending on compounds used for forming the emitting layer.

Next, the electron transporting layer is formed on the emitting layer. As with the hole transporting layer and the emitting layer, the electron transporting layer is also preferably formed by vacuum deposition so as to form a homogeneous film. Deposition conditions for forming the electron transporting layer can be set in the same manner as the hole transporting layer and the emitting layer.

Lastly, the cathode is laminated thereon.

The cathode can be formed from a metal by a method such as vapor deposition and sputtering. In order to protect the organic layers deposited under the cathode from being damaged, the vacuum deposition is preferable.

The above-described organic EL device is preferably manufactured such that all layers from the anode to the cathode are formed in one vacuuming.

The methods for forming each layer of the organic EL device are not particularly limited. Conventionally-known methods such as vacuum deposition, molecular-beam deposition, spin coating, dipping, casting, bar coating and roll coating are applicable to forming the layers.

Although the thickness of each organic layer of the organic EL device is not particularly limited, the thickness is generally preferably in a range of several nanometers to 1 μm because excessively-thinned film likely entails defects such as a pin hole while excessively-thickened film requires high voltage to be applied and deteriorates efficiency. When a voltage is applied to the organic EL device, the light-emission can be observed by applying a voltage of 3 to 40V with the anode having the positive polarity and the cathode having the negative polarity. When the voltage is applied with the inversed polarity, no current flows, so that no light is emitted. When an alternating voltage is applied, the uniform light-emission can be observed only when the anode has the positive polarity and the cathode has the negative polarity. A waveform of the alternating current to be applied may be suitably selected.

### EXAMPLE

Next, the present invention will be further described in detail by exemplifying Examples. However, the present invention is not limited to such Examples.

### Example 1

A 130 nm-thick transparent electrode formed of indium tin oxide was formed on a glass substrate having a size of 25 mm by 75 mm by 0.7 mm. After the transparent substrate was ultrasonically cleaned in isopropyl alcohol for five minutes, the substrate was further cleaned with UV (ultraviolet) ozone for thirty minutes, and then the substrate was mounted on a vapor deposition apparatus.

Initially, N,N′-bis[4-(N,N-diphenylamino)phenyl-1-yl]-N,N′-diphenyl-4,4′-benzidine was deposited on the substrate to form a 60 nm-thick hole injecting layer, and subsequently N,N′-bis[4′-{N-(naphthyl-1-yl)-N-phenyl}aminobiphenyl-4-yl]-N-phenylamine was deposited thereon to form a 10 nm-thick hole transporting layer. Then, the following compound (A-1), a naphthacene derivative, and the following compound (B-1), a diketopyrolopyrrol derivative, were simultaneously deposited thereon by weight ratio of 40 to 0.4 (=0.99 mass %) to form a 40 nm-thick emitting layer.

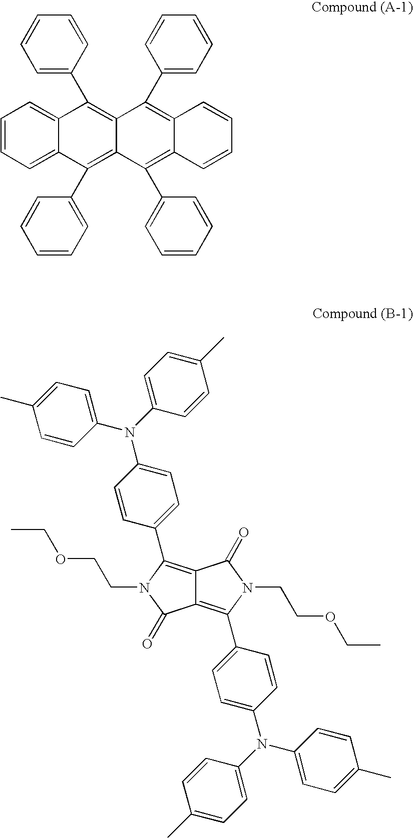

Next, the following compound (C-1) was deposited thereon to form a 30 nm-thick electron transporting layer.

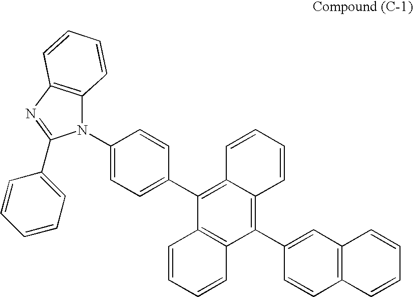

After 0.5 nm-thick lithium fluoride was subsequently deposited thereon, 150 nm-thick aluminum was deposited further thereon. The layer of aluminum/lithium fluoride served as the cathode. The organic EL device was manufactured by the above-described manner.

When a current test was conducted on the obtained device, the organic EL device was driven by a voltage of 4.6 V to emit red light having a luminescence intensity of 623 cd/m² at a current density of 10 mA/cm², a trichromatic coordinate of the emitted light was (0.66, 0.33), and efficiency of the device was 6.23 cd/A. In addition, when a continuous direct-current test was conducted with the initial luminescence intensity set at 5,000 cd/m², time elapsed until the luminescence intensity was reduced by half (i.e., time until half-life) was 2,200 hours.

### Example 2

An organic EL device was manufactured in the same manner as in Example 1 except that the following compound (A-2) was used in place of the compound (A-1) for forming the emitting layer.

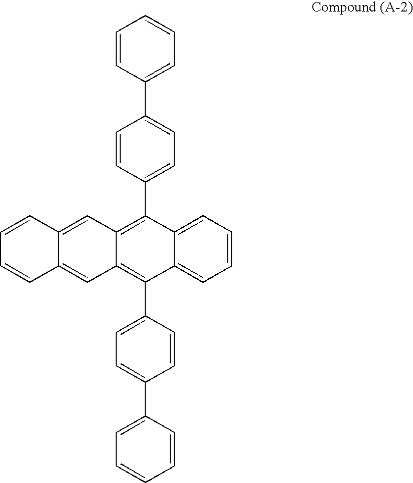

When a current test was conducted on the obtained device, the organic EL device was driven by a voltage of 4.6 V to emit red light having a luminescence intensity of 640 cd/m² at a current density of 10 mA/cm², a trichromatic coordinate of the emitted light was (0.66, 0.33), and efficiency of the device was 6.40 cd/A. In addition, when a continuous direct-current test was conducted with the initial luminescence intensity set at 5,000 cd/m², time elapsed until the luminescence intensity was reduced by half was 2,300 hours.

### Example 3

An organic EL device was manufactured in the same manner as in Example 1 except that the following compound (A-3) was used in place of the compound (A-1) for forming the emitting layer.

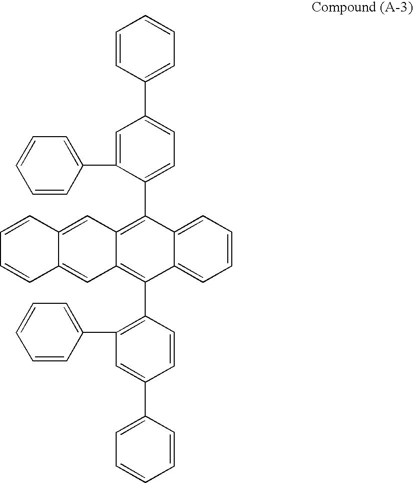

When a current test was conducted on the obtained device, the organic EL device was driven by a voltage of 4.5 V to emit red light having a luminescence intensity of 653 cd/m² at a current density of 10 mA/cm², a trichromatic coordinate of the emitted light was (0.66, 0.33), and efficiency of the device was 6.53 cd/A. In addition, when a continuous direct-current test was conducted with the initial luminescence intensity set at 5,000 cd/m², time elapsed until the luminescence intensity was reduced by half was 3,500 hours.

### Example 4

An organic EL device was manufactured in the same manner as in Example 1 except that the following compound (B-2) was used in place of the compound (B-1) for forming the emitting layer.

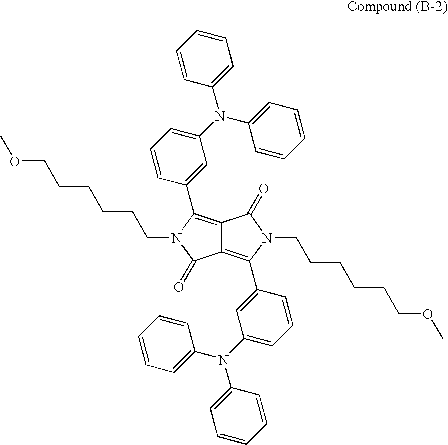

When a current test was conducted on the obtained device, the organic EL device was driven by a voltage of 4.6 V to emit red light having a luminescence intensity of 611 cd/m² at a current density of 10 mA/cm², a trichromatic coordinate of the emitted light was (0.66, 0.33), and efficiency of the device was 6.11 cd/A. In addition, when a continuous direct-current test was conducted with the initial luminescence intensity set at 5,000 cd/m², time elapsed until the luminescence intensity was reduced by half was 2,200 hours.

### Example 5

An organic EL device was manufactured in the same manner as in Example 1 except that the following compound (B-3) was used in place of the compound (B-1) for forming the emitting layer.

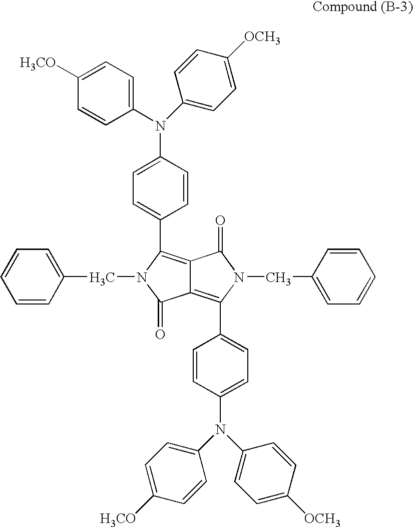

When a current test was conducted on the obtained device, the organic EL device was driven by a voltage of 4.5 V to emit red light having a luminescence intensity of 598 cd/m² at a current density of 10 mA/cm², a trichromatic coordinate of the emitted light was (0.66, 0.33), and efficiency of the device was 5.98 cd/A. In addition, when a continuous direct-current test was conducted with the initial luminescence intensity set at 5,000 cd/m², time elapsed until the luminescence intensity was reduced by half was 1,500 hours.

### Example 6

An organic EL device was manufactured in the same manner as in Example 1 except that the following compound (B-4) was used in place of the compound (B-1) for forming the emitting layer.

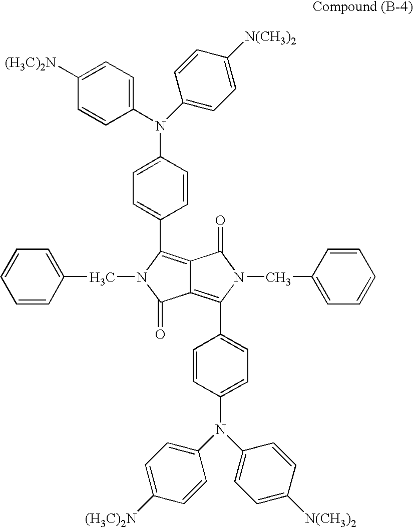

When a current test was conducted on the obtained device, the organic EL device was driven by a voltage of 4.6 V to emit red light having a luminescence intensity of 606 cd/m² at a current density of 10 mA/cm², a trichromatic coordinate of the emitted light was (0.66, 0.33), and efficiency of the device was 6.06 cd/A. In addition, when a continuous direct-current test was conducted with the initial luminescence intensity set at 5,000 cd/m², time elapsed until the luminescence intensity was reduced by half was 1,300 hours.

### Example 7

An organic EL device was manufactured in the same manner as in Example 1 except that the following compound (C-2) was used in place of the compound (C-1) for forming the electron transporting layer.

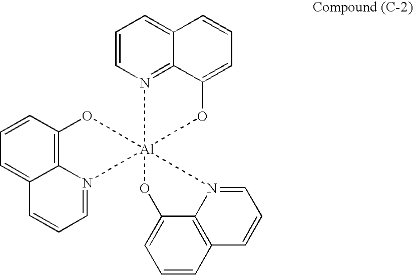

When a current test was conducted on the obtained device, the organic EL device was driven by a voltage of 5.3 V to emit red light having a luminescence intensity of 512 cd/m² at a current density of 10 mA/cm², a trichromatic coordinate of the emitted light was (0.64, 0.35), and efficiency of the device was 5.12 cd/A. In addition, when a continuous direct-current test was conducted with the initial luminescence intensity set at 5,000 cd/m², time elapsed until the luminescence intensity was reduced by half was 1,000 hours.

### Comparative 1

An organic EL device was manufactured in the same manner as in Example 7 except that the following compound (C-2) was used in place of the compound (A-1) for forming the emitting layer.

When a current test was conducted on the obtained device, the organic EL device was driven by a voltage of 6.0 V to emit red light having a luminescence intensity of 411 cd/m² at a current density of 10 mA/cm², a trichromatic coordinate of the emitted light was (0.63, 0.35), and efficiency of the device was 4.11 cd/A. In addition, when a continuous direct-current test was conducted with the initial luminescence intensity set at 5,000 cd/m², time elapsed until the luminescence intensity was reduced by half was 600 hours.

### Comparative 2

An organic EL device was manufactured in the same manner as in Example 1 except that the following compound (B-5) was used in place of the compound (B-1) for forming the emitting layer.

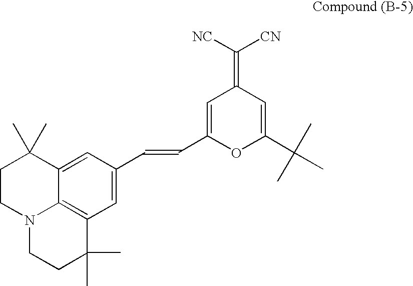

When a current test was conducted on the obtained device, the organic EL device was driven by a voltage of 4.7 V to emit red light having a luminescence intensity of 385 cd/m² at a current density of 10 mA/cm², a trichromatic coordinate of the emitted light was (0.64, 0.37), and efficiency of the device was 3.85 cd/A. In addition, when a continuous direct-current test was conducted with the initial luminescence intensity set at 5,000 cd/m², time elapsed until the luminescence intensity was reduced by half was 700 hours.

### Comparative 3

An organic EL device was manufactured in the same manner as in Example 1 except that the following compound (C-2) was used in place of the compound (A-1) for forming the emitting layer.

When a current test was conducted on the obtained device, the organic EL device was driven by a voltage of 5.0 V to emit red light having a luminescence intensity of 432 cd/m² at a current density of 10 mA/cm², a trichromatic coordinate of the emitted light was (0.64, 0.35), and efficiency of the device was 4.32 cd/A. In addition, when a continuous direct-current test was conducted with the initial luminescence intensity set at 5,000 cd/m², time elapsed until the luminescence intensity was reduced by half was 600 hours.

TABLE 1

| | Drive | lumi- | | Luminous | |
|---|---|---|---|---|---|
| | Volt- | nescence | | Effi- | time until |
| | age | intensity | trichromatic | ciency | half-life |
| | (V) | (cd/m²) | coordinate | (cd/A) | (hr) |
| Example 1 | 4.6 | 623 | (0.66, 0.33) | 6.23 | 2,200 |
| Example 2 | 4.6 | 640 | (0.66, 0.33) | 6.40 | 2,300 |
| Example 3 | 4.5 | 653 | (0.66, 0.33) | 6.53 | 3,500 |
| Example 4 | 4.6 | 611 | (0.66, 0.33) | 6.11 | 2,200 |
| Example 5 | 4.5 | 598 | (0.66, 0.33) | 5.98 | 1,500 |
| Example 6 | 4.6 | 606 | (0.66, 0.33) | 6.06 | 1,300 |
| Example 7 | 5.3 | 512 | (0.64, 0.35) | 5.12 | 1,000 |
| Comparative 1 | 6.0 | 411 | (0.63, 0.35) | 4.11 | 600 |
| Comparative 2 | 4.7 | 385 | (0.64, 0.37) | 3.85 | 700 |
| Comparative 3 | 5.0 | 432 | (0.64, 0.35) | 4.32 | 600 |

It is understood from a comparison between Example 7 and Comparative 1 that Example 7, in which the compound (A-1) was used as the host, is more excellent in drive voltage, luminescence intensity, chromaticity and time until half-life.

In other words, a combination of the compound (A-1) and the compound (B-1) as the combination of the host and the dopant is more excellent than a combination of the compound (C-2), a general host material, and the compound (B-1).

In Examples 1 to 6 and Comparatives 2 and 3, the compound (C-1) was used as the electron transporting layer. The compound (B-5) was used as the dopant in Comparative 2 while the compound (C-2) was used as the host in Comparative 3. In contrast, the combination of the host and the dopant according to the present invention was used in Examples 1 to 6.

Consequently, the combination of the host and the dopant according to the present invention is excellent in terms of drive voltage, luminescence intensity, chromaticity, luminous efficiency and time until half-life.

In other words, irrespective of what compound is used for forming the electron transporting layer, the combination of the host material and the dopant material according to the present invention is excellent in terms of drive voltage, luminescence intensity, chromaticity, efficiency and time until half-life.

It is understood from a comparison between Examples 1 to 6 and Example 7 that, by using such a material as represented by the compound (C-1) according to the present invention for the electron transporting material, the device can exhibit excellent performance in terms of drive voltage, luminescence intensity, chromaticity, efficiency, time until half-time and the like.

The emitting region is typically preferably located within the emitting layer in the organic EL device. On the other hand, an emitting material for emitting red light tends to cause electron traps because an energy gap of the dopant is small. Accordingly, the electrons injected into the emitting layer from the electron transporting layer tend to be trapped in the dopant located adjacent to the electron transporting layer, thereby moving the emitting region toward the electron transporting layer.

In Example 7, the chromaticity was shifted toward green, and the compound (C-2) emitted light. It can be deduced from the above with respect to Example 7 that the holes were more strongly injected into the emitting layer than the electrons, and that many of the holes penetrated the emitting layer to reach the electron transporting layer, thereby generating exciters in the compound (C-2) forming the electron transporting layer. In addition, since the compound (C-2) emitted light, the time elapsed until the lifetime of the organic EL device was reduced by half is short.

In this respect, the electron transporting material according to the present invention, a representative example of which is the compound (C-1), is excellent in transporting electrons. The electron transporting layer formed of such an electron transporting material can strongly inject the electrons into the emitting layer, thereby preventing the holes from penetrating the emitting layer to reach the electron transporting layer.

In other words, the organic EL device according to the present invention can emit light of high chromaticity with high efficiency while preventing generation of exciters in the electron transporting layer, and lifetime of the entire device is long.

In addition, when a naphthacene derivative and a diketopyrolopyrrol derivative are respectively used for the host and the dopant, the electron transporting material can exhibit above-described excellent effects and advantages.

Lifetime of Example 3 is much longer than those of Examples 1 and 2 because the compound A-3 was used for the host in Example 3. It has been revealed from the above that substituent(s) in ortho position(s) of benzene rings bonded to the naphthacene skeleton prevents molecular association, thereby contributing to longer lifetime.

The present invention is not limited to the above examples, but includes modifications and improvements made within a scope where an object of the present invention can be achieved.

For instance, ruburene, which is an example of the host material of Example 1, may be substituted or unsubstituted. In addition, the compounds used in the other Examples may be substituted or unsubstituted.

The priority application Number JP2007-061092 upon which this patent application is based is hereby incorporated by reference.

What is claimed is:

1. An organic electroluminescence device, comprising:
a cathode;
an anode; and
an emitting layer provided between the cathode and the anode, wherein
the emitting layer comprises a host and a dopant,
the host is a naphthacene derivative represented by a formula (1) as follows, and
the dopant is a diketopyrolopyrrol derivative represented by a formula (2) as follows, 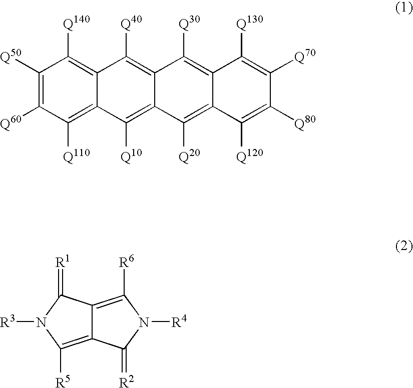
in the formula (1), Q¹⁰, Q²⁰, Q³⁰, Q⁴⁰, Q⁵⁰, Q⁶⁰, Q⁷⁰, Q⁸⁰, Q¹¹⁰, Q¹²⁰, Q¹³⁰ and Q¹⁴⁰ each representing a hydrogen atom, a substituted or unsubstituted alkyl group having 1 to 20 carbon atoms, a substituted or unsubstituted aryl group having 6 to 30 carbon atoms, a substituted or unsubstituted amino group, a substituted or unsubstituted alkoxy group having 1 to 20 carbon atoms, a substituted or unsubstituted alkylthio group having 1 to 20 carbon atoms, a substituted or unsubstituted aryloxy group having 6 to 30 carbon atoms, a substituted or unsubstituted arylthio group having 6 to 30 carbon atoms, a substituted or unsubstituted alkenyl group having 1 to 20 carbon atoms, a substituted or unsubstituted aralkyl group having 7 to 30 carbon atoms, or a substituted or unsubstituted heterocyclic group, Q¹⁰, Q²⁰, Q³⁰, Q⁴⁰, Q⁵⁰, Q⁶⁰, Q⁷⁰, Q⁸⁰, Q¹¹⁰, Q¹²⁰, Q¹³⁰ and Q¹⁴⁰ being allowed to be mutually the same or different, and
in the formula (2): R¹ and R² each representing an oxygen atom or a nitrogen atom substituted by a cyano group; R³ and R⁴ each representing a hydrogen atom, a halogen atom, an alkyl group, an alkenyl group, an aryl group, a heterocyclic group or COOR⁷, R⁷ representing an alkyl group, an alkenyl group, an aryl group or a heterocyclic group; and R⁵ and R⁶ each representing an aryl group or a heterocyclic group.

2. The organic electroluminescence device according to claim 1, wherein the diketopyrolopyrrol derivative represented by the formula (2) is a diketopyrolopyrrol derivative represented by a formula (2-1) as follows, 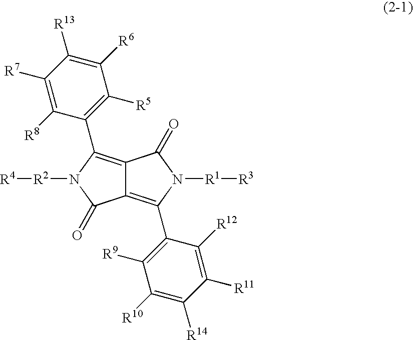
in the formula (2-1): R¹ and R² each representing a substituted or unsubstituted alkylene group; R³ and R⁴ each representing a substituted or unsubstituted aliphatic heterocyclic group or a substituent represented by a formula (2-2) as follows; and R⁵ to R¹⁴ each representing a hydrogen atom or a substituent, at least one of R⁵ to R¹⁴ being an amino group represented by a formula (2-3) as follows,
-X—R¹⁵ (2-2)
in the formula (2-2): X representing an oxygen atom or a sulfur atom; R¹⁵ representing substituted or unsubstituted univalent aliphatic hydrocarbon, substituted or unsubstituted univalent aromatic hydrocarbon or a substituted or unsubstituted univalent aromatic heterocyclic group, and 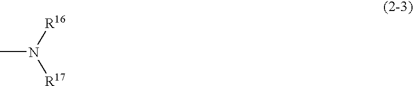
in the formula (2-3), R¹⁶ and R¹⁷ each representing a hydrogen atom, substituted or unsubstituted univalent aliphatic hydrocarbon, substituted or unsubstituted univalent aromatic hydrocarbon or a substituted or unsubstituted univalent aromatic heterocyclic group.

3. The organic electroluminescence device according to claim 1, wherein the diketopyrolopyrrol derivative represented by the formula (2) is a diketopyrolopyrrol derivative represented by a formula (2-4) as follows, 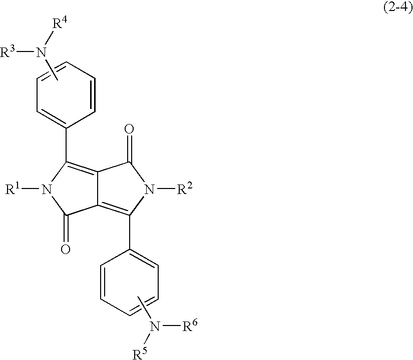
in the formula (24), R¹ to R⁶ each representing a substituted or unsubstituted alkyl group, a substituted or unsubstituted aryl group, or a substituted or unsubstituted heterocyclic group,
in the formula (2-4): R¹ and R² each representing a substituted or unsubstituted alkylene group; R³ and R⁴ each representing a substituted or unsubstituted aliphatic heterocyclic group or a substituent represented by a formula (2-5) as follows; R⁵ to R¹² each representing a hydrogen atom or a substituent; and R¹⁸ to R²¹ each representing a hydrogen atom, a substituted or unsubstituted univalent aliphatic hydrocarbon group, a substituted or unsubstituted univalent aromatic hydrocarbon group, or a substituted or unsubstituted univalent aromatic heterocyclic group, and
-X—R¹⁵ (2-5)
in the formula (2-5); X representing an oxygen atom or a sulfur atom; R¹⁵ representing substituted or unsubstituted univalent aliphatic hydrocarbon, substituted or unsubstituted univalent aromatic hydrocarbon or a substituted or unsubstituted univalent aromatic heterocyclic group.

4. The organic electroluminescence device according to claim 1, wherein the diketopyrolopyrrol derivative represented by the formula (2) is a diketopyrolopyrrol derivative represented by a formula (2-6) as follows, 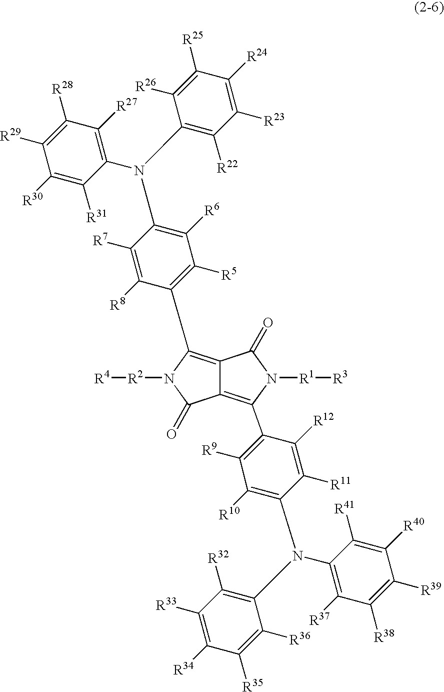
in the formula (2-6): R¹ and R² each representing a substituted or unsubstituted alkylene group; R³ and R⁴ each representing a substituted or unsubstituted aliphatic heterocyclic group or a substituent represented by a formula (2-7) as follows; R⁵ to R¹² each representing a hydrogen atom or a substituent; and R⁵ to R¹² and R²² to R⁴¹ each representing a hydrogen atom or a substituent,
-X—R¹⁵ (2-7)
in the formula (2-7); X representing an oxygen atom or a sulfur atom; and R¹⁵ representing substituted or unsubstituted univalent aliphatic hydrocarbon, substituted or unsubstituted univalent aromatic hydrocarbon or a substituted or unsubstituted univalent aromatic heterocyclic group.

5. The organic electroluminescence device according to claim 1, wherein at least one of Q¹⁰, Q²⁰, Q³⁰ and Q⁴⁰ in the naphthacene derivative represented by the formula (1) is a substituted or unsubstituted aryl group having 6 to 30 carbon atoms.

6. The organic electroluminescence device according to claim 1, wherein the naphthacene derivative represented by the formula (1) is a naphthacene derivative represented by a formula (3) as follows, 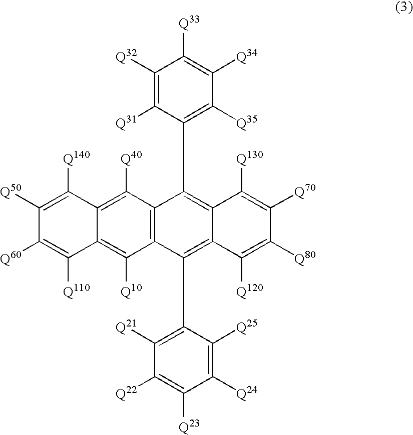
where Q¹⁰, Q²¹ to Q²⁵, Q³¹ to Q³⁵, Q⁴⁰ to Q⁸⁰ and Q¹¹⁰ to Q¹⁴⁰ each represent a hydrogen atom, a substituted or unsubstituted alkyl group, a substituted or unsubstituted aryl group, a substituted or unsubstituted amino group, a substituted or unsubstituted alkoxy group, a substituted or unsubstituted alkylthio group, a substituted or unsubstituted aryloxy group, a substituted or unsubstituted arylthio group, a substituted or unsubstituted alkenyl group, a substituted or unsubstituted aralkyl group, or a substituted or unsubstituted heterocyclic group, Q¹⁰, Q²¹ to Q²⁵, Q³¹ to Q³⁵, Q⁴⁰ to Q⁸⁰ and Q¹¹⁰ to Q¹⁴⁰ being allowed to be mutually the same or different, adjacent two or more of Q²¹ to Q²⁵ and Q³¹ to Q³⁵ being allowed to be mutually bonded to form a cyclic structure.

7. The organic electroluminescence device according to claim 6, wherein at least one of Q²¹, Q²⁵, Q³¹ an Q³⁵ in the naphthacene derivative represented by the formula (3) represents a substituted or unsubstituted alkyl group, a substituted or unsubstituted aryl group, a substituted or unsubstituted amino group, a substituted or unsubstituted alkoxy group, a substituted or unsubstituted alkylthio group, a substituted or unsubstituted aryloxy group, a substituted or unsubstituted arylthio group, a substituted or unsubstituted alkenyl group, a substituted or unsubstituted aralkyl group, or a heterocyclic group.

8. The organic electroluminescence device according to claim 1, wherein the dopant is contained in the emitting layer at a doping concentration of 0.1 to 10 mass %.

9. The organic electroluminescence device according to claim 8, wherein the dopant is contained in the emitting layer at a doping concentration of 0.5 to 2.0 mass %.

10. The organic electroluminescence device according to claim 1, further comprising
an electron transporting layer provided between the cathode and the anode, wherein the electron transporting layer comprises a compound represented by a formula (4) as follows,
(A)ₘ-(B)ₙ (4)
where: A represents a condensed aromatic hydrocarbon group having three or more rings; B represents a substituted or unsubstituted heterocyclic group; and m and n each represent an integer in a range of 1 to 6.

11. The organic electroluminescence device according to claim 10, wherein A in the compound represented by the formula (4) has a skeleton in its molecule, the skeleton selected from a group consisting of anthracene, phenanthrene, naphthacene, pyrene, chrysene, benzoanthracene, pentacene, dibenzoanthracene, benzopyrene, florene, benzoflorene, fluoranthene, benzofluoranthene, naphthofluoranthene, dibenzoflorene, dibenzopyrene and dibenzofluoranthene.

12. The organic electroluminescence device according to claim 10, wherein B in the compound represented by the formula (4) is a nitrogen-containing heterocyclic group.

13. The organic electroluminescence device according to claim 12, wherein B in the compound represented by the formula (4) has a skeleton in its molecule, the skeleton selected from a group consisting of pyridine, pyrimidine, pyrazine, pyridazine, triazine, quinoline, quinoxaline, acridine, imidazopyridine, imidazopyrimidine, phenanthroline, pyrazole, imidazole and benzoimidazole.

14. The organic electroluminescence device according to claim 13, wherein the compound represented by the formula (4) is a benzoimidazole derivative represented by a formula (5) or a formula (6) as follows, 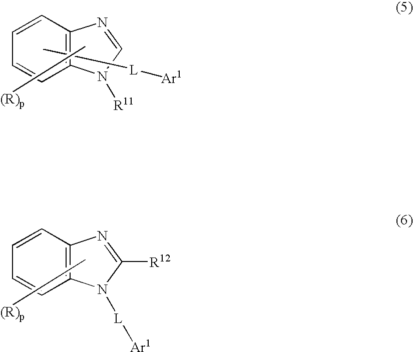
where: R represents a hydrogen atom, a substituted or unsubstituted aryl group having 6 to 60 carbon atoms, a substituted or unsubstituted pyridyl group, a substituted or unsubstituted quinolyl group, a substituted or unsubstituted alkyl group having 1 to 20 carbon atoms or a substituted or unsubstituted alkoxy group having 1 to 20 carbon atoms; p represents an integer in a range of 1 to 4; R¹¹ represents a substituted or unsubstituted aryl group having 6 to 60 carbon atoms, a substituted or unsubstituted pyridyl group, a substituted or unsubstituted quinolyl group, a substituted or unsubstituted alkyl group having 1 to 20 carbon atoms or an alkoxy group having 1 to 20 carbon atoms; R¹² represents a hydrogen atom, a substituted or unsubstituted aryl group having 6 to 60 carbon atoms, a substituted or unsubstituted pyridyl group, a substituted or unsubstituted quinolyl group, a substituted or unsubstituted alkyl group having 1 to 20 carbon atoms or a substituted or unsubstituted alkoxy group having 1 to 20 carbon atoms; L represents a substituted or unsubstituted arylene group having 6 to 60 carbon atoms, a substituted or unsubstituted pyridnylene group, a substituted or unsubstituted quinolinylene group, a substituted or unsubstituted fluorenylene group; and Ar¹ represents a substituted or unsubstituted aryl group having 6 to 60 carbon atoms, a substituted or unsubstituted pyridyl group or a substituted or unsubstituted quinolyl group, at least one of R, R¹¹, R¹², L and Ar¹ corresponding to A in the compound represented by the formula (4) and being a condensed aromatic hydrocarbon group having three or more rings.

15. The organic electroluminescence device according to claim 1, wherein the emitting layer emits light of orange to red.

16. A display, comprising the organic electroluminescence device according to claim 1.
